(19) United States
(12) Patent Application Publication
(10) Pub. No.: US 2024/0097925 A1
(43) Pub. Date: Mar. 21, 2024

(54) INTELLIGENT MANAGEMENT OF ADAPTABLE AUDIO-VISUALS OF VIDEO CONFERENCING SESSIONS

(71) Applicant: AT&T Intellectual Property I, L.P., Atlanta, GA (US)

(72) Inventors: Rashmi Palamadai, Naperville, IL (US); Yupeng Jia, Austin, TX (US)

(21) Appl. No.: 17/932,563

(22) Filed: Sep. 15, 2022

(51) Int. Cl. H04L 12/18; H04N 7/15; H04N 21/439; H04N 21/44; H04N 21/4788

(52) U.S. Cl. CPC H04L 12/1822; H04N 7/15; H04N 21/4394; H04N 21/44008; H04N 21/4788

(57) ABSTRACT

Techniques are described that facilitate intelligent management of adaptable audio-visuals of cloud-based video conferencing sessions. In one example embodiment, method comprises determining, by a system comprising a processor, capabilities of respective devices of participants of a video conferencing session provisioned via a communication network, the capabilities comprising audio-visual capabilities and connection capabilities of the respective devices related to communicating respective data streams of the video conferencing session via the communication network. The method further comprises determining, by the system, respective audio-visual settings of the video conferencing session applicable to the respective devices as a function of the capabilities of the respective devices, and controlling, by the system, performance of the video conferencing session at the respective devices in accordance with the respective audio-visual settings.

### TECHNICAL FIELD

This disclosure relates to intelligent management of adaptable audio-visuals of cloud-based video conferencing sessions.

### BACKGROUND

Video conferencing technology allows two or more people to emulate a person-to-person meeting over the Internet using real-time, multidirectional video and audio streaming. Video conferencing is an increasingly indispensable tool for facilitating professional collaborations and team projects when people are unable to meet up in person. For many companies, it also helps them to reduce their reliance on physical spaces, saving costs on office rental and venue hire. Video conferencing technology has also become extremely popular for connecting remote individuals virtually for social gatherings as well.

Initially, video conferencing software only enabled users to make video calls or hold group video conferences. However, as technology advanced, video conferencing software has developed helpful tools and features for remote communication and learning. Today, video conferencing is, rather, a tool for integrated video collaboration and unified communications platforms that also offer screen sharing, slideshow, recording, instant messaging, project management tools, and telephony integration among other features.

Despite the many advantages of advanced video conferencing technology, the technology is not devoid of drawbacks. One of the primary complaints of video conferencing communication is the lack of authentic and natural interpersonal interaction associated with virtual meeting experiences. For example, the lack of eye contact and conveyance of non-verbal cues can make the experience slightly less personal than in-person meetings. Additionally, when in a mixed videoconference including individual remote participants and a group of in-person participants located in the same physical room, there is a clear disadvantage to those individual remote participants as they typically cannot see or hear everything that is being said in the room, and they often miss the important facial and body language visuals. Video conferencing technology also suffers from technical issues related to network connectivity, user equipment incompatibility, and user unfamiliarity and/or lack of technical training with the videoconferencing software/system. These issues are compounded as the number of participants in the virtual meetings/gathering increases. Accordingly, techniques for improving video conferencing experiences and reducing technical issues are in high demand.

### DESCRIPTION OF THE DRAWINGS

FIG. 1 illustrates an example, high-level architecture diagram of a non-limiting system that facilitates intelligent management of adaptable audio-visuals of cloud-based video conferencing sessions in accordance with one or more embodiments of the disclosed subject matter.

FIG. 2 illustrates another example, high-level architecture diagram of a non-limiting system that facilitates intelligent management of adaptable audio-visuals of cloud-based video conferencing sessions in accordance with one or more embodiments of the disclosed subject matter.

FIG. 3 presents an example video conferencing system in accordance with one or more embodiments of the disclosed subject matter.

FIG. 4 presents an example lead session management (LSM) component in accordance with one or more embodiments of the disclosed subject matter.

FIG. 5 presents an example audio-visual management component in accordance with one or more embodiments of the disclosed subject matter.

FIG. 6 illustrates a high-level flow diagram of an example computer-implemented process that facilitates intelligent management of adaptable audio-visuals of cloud-based video conferencing sessions in accordance with one or more embodiments of the disclosed subject matter.

FIG. 7 illustrates a high-level flow diagram of another example computer-implemented process that facilitates intelligent management of adaptable audio-visuals of cloud-based video conferencing sessions in accordance with one or more embodiments of the disclosed subject matter.

FIG. 8 illustrates a high-level flow diagram of another example computer-implemented process that facilitates intelligent management of adaptable audio-visuals of cloud-based video conferencing sessions in accordance with one or more embodiments of the disclosed subject matter.

FIG. 9 illustrates a block diagram of an example, non-limiting operating environment in which one or more embodiments described herein can be facilitated.

FIG. 10 illustrates a block diagram of another example, non-limiting operating environment in which one or more embodiments described herein can be facilitated.

FIG. 11 illustrates an example schematic system block diagram of an edge network according to one or more embodiments.

### DETAILED DESCRIPTION

The following detailed description is merely illustrative and is not intended to limit embodiments and/or application or uses of embodiments. Furthermore, there is no intention to be bound by any expressed or implied information presented in the preceding Background section, or in this Detailed Description section.

The disclosed subject matter is directed to a cloud-based or web-based video conferencing system that facilitates intelligent management of adaptable audio-visuals of video conferencing sessions. The disclosed system provides for automatically determining, applying and adapting various audio and visual parameters or settings of a videoconferencing session in real-time to optimize the experience for individual participants while harmonizing the experience for all participants. To facilitate this end, the disclosed system incorporates an intelligent session management functionality.

In various embodiments, the intelligent session management functionality employs a lead session manager (referred to herein as the lead session management (LSM) component) deployed at a cloud-based server of the video conferencing system that manages the audio-visual settings of all participant devices. In some embodiments, the video conferencing system can employ an edge computing architecture and the LSM component can be deployed at one or more edge servers of the video-conferencing system. The LSM component can determine and apply optimal improved (e.g., increased) or preferred audio and visual parameters or settings for respective participant devices in a manner that optimizes the video conferencing experience based on respective audio-visual capabilities of the participant devices, network connectivity of the participant devices, the context of the video conferencing session, individual preferences of the participants, and various events that occur throughout the video conferring session detected based on analysis of monitored session audio and visual data.

In one or more embodiments, the optimal, improved or preferred audio-visual parameters or settings can include optimal, improved or preferred measures of audio and video quality of respective audio and video content of respective data streams of the video conferencing session. The rendering quality of the audio and video content of a video conferencing session is multifactorial and based on the quality of the respective audio-visual capture equipment of the respective participant devices (e.g., microphones, cameras, web-cameras, etc.), the rendering quality capabilities of the respective participant devices (e.g., speakers, display devices/monitors), the audio-image data processing capabilities of the participant devices (e.g., codec and other processing capabilities), and the quality of the respective network connections and corresponding communications channels of the participant devices used to communicate the respective data streams between the participant devices (e.g., as a function of uplink (UL and downlink (DL) speeds and other communication performance metrics, which can vary as a function connection type (e.g., Wi-Fi, wired/wireless, fiber, cellular 3G, cellular LTE, cellular 5G, satellite, etc.), connection bandwidth, network load, channel quality, channel routing and path length, etc.).

In various embodiments, upon initialization of a video conferencing session, the LSM component can determine optimal, improved, or preferred measures of audio and video quality of audio and video data components of respective data streams to be captured and transmitted and/or received and rendered by the respective participant devices as a function of an assessment of the state of these multi-factors for the respective devices at the time of initiation of the video conferencing session. In association with determining the optimal, improved, or preferred measures of audio and video quality, the LSM component can determine the optimal, improved, or preferred measures of audio and video quality for each of the participant devices that balance the respective audio-visual capabilities and network connection capabilities of the participant devices and accounts for their differences. The LSM component can further tailor the optimal or improved audio and video quality measures for the respective participant devices of session based on a context of the session, the relative importance of audio and video quality as a function of the context of the session, and relative difficulties associated with maintaining certain levels of audio and video quality as a function of the context of the session and user preferences. In this regard, the context of the session can reflect the type of session (e.g., a business/work conference, a social gathering, a musical performance, a fitness class, etc.), the number of participants, the identities of the participants, the locations of the participant devices, the mobility states of the participant devices, and various other factors.

The LSM component can further control performance of the video conferencing session to achieve the optimal, improved, or preferred audio and video quality measures. For example, in some embodiments, the LSM component can direct the respective participant devices to capture respective audio and video components at a specific audio and video quality levels and render the respective audio and video components at specific audio and video quality levels, which may be lower than their maximum quality level capabilities. In some embodiments, the LSM component can intercept and process one or more of the audio-visual data streams to convert the audio and/or video components thereof into a different format and/or quality level (e.g., from low definition to high definition or vice versa). Still, in other embodiments, the LSM component can control allocation of network resources of the communication network used to perform the video conferencing session to achieve the optimal or improved levels of audio and video quality.

The LSM component can further constantly or repeatedly monitor and adjust the respective audio-video data stream quality levels throughout the duration of the video conferencing session to account for changes in network conditions (e.g., changes in UL/DL rates, load, bandwidth, latency, etc.) and adjust and re-allocate network system resources to improve video and audio quality within a room and virtually. In some embodiments, this can involve determining and controlling communication parameters and settings of the communication network used to communicate the data streams between the respective devices (e.g., controlling one or more of, an UL rate, a DL rate, a latency parameter, a reliability parameter, a routing parameter, and so on). For example, the LSM component can monitor and adapt communication parameters and settings that control the resulting level of the quality of the data streams transmitted and received by the respective devices in real-time to account for changes network conditions and communication channel issues that influence UL and DL rates (e.g., load) as well as changes device mobility (e.g., speed, handovers, etc.) in implementations in which one or more participant devices are mobile. For example, the LSM component can detect issues related to audio data and/or video data communication delays and errors that result in degraded quality of audio and/or video rendering at one or more participant devices, such as slowed audio/visual data rendering, pauses or gaps in audio/visual data rendering, and skipped or missed audio/visual data rendering. In some embodiments, the LSM component can predict communication delays ahead of time using a time average model and react accordingly to minimize the impact of the delays by adjusting one or more communication parameters and/or re-allocation network resource to counteract the resulting impact on audio-visual quality at the respective device. In this regard, the LSM component can find the appropriate “balance point” between all entities to ensure that the optimal or improved voice and video quality remains in place for the duration of the meeting/gathering while accounting for changes in network conditions and connectivity capabilities of the respective devices.

In some embodiments, the LSM component can respond to communication delays by providing additionally or alternative audio-visual content. For example, the LSM component can detect visual content frame rendering “freezes” attributed to data communication delays that result in a participant's video stream appearing frozen at another participant's device, such as a frozen and unflattering facial expression. In another example, the LSM component can detect delays in audio a participant's audio stream that result in the participant's voice coming across as stuttering. The LSM component can further perform various intelligent responses to account for these issues that minimize and/or counteract their negative impact on the participants session experience. For example, in some embodiments, the LSM component can employ preloaded audio/visual data for respective participants and employ this preloaded content to fill gaps or delays. For instance, the LSM can select preloaded image and/or video content of a participant (and/or an avatar representation of the participant) for rendering instead of a blank screen or frozen, unflattering image of the participant face. The LSM component can further control rendering of the preloaded image and/or video content at the participants device during the delay.

The LSM component can also tailor the quality levels of the respective audio-visual data streams communicated between the participant devices based on a context of the video conferencing session and various relevant contextual information about the video conferencing session regarding the type of the video conferencing session and the type of user interaction to be captured and conveyed during the session. In this regard, depending on the type of the session, the optimal or improved levels of quality of the audio-visual data streams can vary and the acceptable ranges for adjusting the quality levels of the audio-visual data streams (e.g., increasing relative to a maximum level or decreasing relative to a minimum level) can also vary. In addition, depending on the type of the session, the quality of video may be more important than the quality of audio, or vice versa. For example, the quality of the audio component of a musical performance type session can be considered more important than the quality of the video component. In accordance with this example, assuming a network connectivity issue degrades the UP and/or DL rate associated with the data stream being transmitted from and/or received by a participant device, the LSM component can reduce the quality of the video component of the data stream to maintain a desired level of quality of the audio component of the data stream in real-time.

The LSM component can further monitor and analyze the content of the audio-visual data streams of a video conferencing session to detect relevant events that indicate a need to adjust the quality of the audio component and/or video component of the corresponding data stream. For instance, in furtherance to the musical performance example, the LSM component can monitor the audio and/or video content of a data stream during the session to detect pauses or breaks in the musical performance, such as breaks between songs or other event when the music/sound is not in the forefront of the session, such as a lowered period of music in which an image slideshow or another visual demonstration is featured. The LSM component can further increase the quality of the visual component of the data stream relative to the quality of the audio-component of the data stream during this period of time when the video element is more important. The LSM component can also detect who is speaking and who is not speaking over the course of a session and change audio-visual settings of the data streams to enhance the quality of the speakers for the time of speaking (e.g., focus network resources on the speaker data stream to give them a higher audio and/or visual quality relative to the other data streams of participants not speaking or talking). In this regard, the LSM component can independently control the quality of the audio and video components of the data streams of a video conferencing session as needed throughout the session based on the relative importance of the respective components with respect to the audio-visual events that occur throughout the session.

In addition to quality related audio-visual parameters, the LSM component can also control other audio-visual parameters or settings of a video conferencing session in a manner that optimizes the experience for individual participants and/or all participants collectively. In various embodiments, the other audio-visual parameters and settings can include parameters and settings that control the actual content of audio-visual data streams that is rendered to other participants. For example, the LSM component can control the actual content of audio-visual data streams by applying various filters and/or via audio-visual editing techniques, and/or by controlling the audio/visual data capture at one or more participant devices (e.g., controlling the respective camera zoom level, orientation, and/or position). In this regard, some cloud-based video conferencing platforms (e.g., Zoom™) include features such as such as suppressing background noise, applying backdrops/backgrounds, and applying imaging filters to change the appearance of your face (e.g., any image type filters and snapchat filters). However, all of these features are selected and controlled locally at the client side by the user. Once selected they are applied and not adjusted or removed unless the user manually changes the settings via the client side.

On the contrary, the disclosed LSM can automatically control and adapt the way respective participants look and sound to others based on their individual preferences and the context of the session by automatically applying various audio-visual filters to the data streams, performing automated audio-visual editing techniques, and/or by controlling the audio/visual data capture at one or more participant devices (e.g., controlling the respective camera zoom level, orientation, and/or position). In this manner, the LSM component can correspond to a live (e.g., in real-time or substantially real-time), intelligent audio-visual director, producer and editor of the image and audio content of a video conference, tailoring the image and video content presented to respective participants individual and collectively in a manner that optimizes the experience for all participants. In additions, users do not need to worry about having the technical expertise of the videoconferencing software to control the audio-visual settings themselves.

In some embodiments, in addition to the centralized LSM component, one or more of the participant devices can employ a local participant version of the LSM component, referred to herein as a participant session manager component (PSM). With these embodiments, the PSM can perform same or similar functions as the LSM component yet tailored to specifically optimizing one or more audio-visual parameters or settings of the corresponding participant device. For example, the PSM can determine, apply and/or adapt one or more audio-visual parameters and/or settings at a participant device in an automated manner as discussed with reference to the LSM component. The PSMs can further coordinate and communicate with the LSM component to facilitate harmonizing the audio-visual parameters of the participant devices with one another in a manner that balances the experience for all devices collectively.

In various embodiments, the LSM component can further employ machine (ML) learning and artificial intelligence (AI) techniques to learn optimal or improved audio-visual parameters and settings for different types of conferencing sessions under different contexts and network conditions. The LSM component can further generate predefined audio-visual parameter setting templates for the different types of conferencing sessions, contexts and network conditions and employ the template configurations in association with determining, applying and adjusting the audio-visual parameters and settings for similar video conferencing sessions. The LSM component can also employ ML and AI techniques to learn user preferences regarding preferred audio-visual parameters and settings and apply these preferences in future video conferencing sessions in which the users participate.

In one or more embodiments, a system is provided that facilitates intelligent management of adaptable audio-visuals of cloud-based video conferencing sessions. The system comprises a processor and a memory that stores executable instructions that, when executed by the processor, facilitate performance of operations. The operations comprise determining capabilities of respective devices of participants of a video conferencing session provisioned via a communication network, the capabilities comprising audio-visual capabilities and connection capabilities of the respective devices related to communicating respective data streams of the video conferencing session via the communication network. The operations further comprise determining respective audio-visual parameters of the video conferencing session applicable to the respective devices as a function of the capabilities of the respective devices, and controlling performance of the video conferencing session at the respective devices in accordance with the respective audio-visual parameters.

In one or more implementations, the respective audio-visual parameters represent respective measures of audio and video quality and wherein the determining respective audio-visual parameters comprises determining the respective audio-visual parameters to balance the respective measures of audio and video quality at the respective devices. The operations can further comprise monitoring the respective measures of audio and video quality at the respective devices during the video conferencing session, and adapting the respective audio-visual parameters based on changes to the respective measures of audio and video quality. In some implementations, the controlling comprises controlling respective communication parameters applicable to communicating the respective data streams in accordance with the respective audio-visual parameters. For example, the respective communication parameters can include (but are not limited to): a downlink speed parameter, an uplink speed parameter, a latency parameter, and a reliability parameter. With these implementations, the operations can further comprise monitoring the respective measures of audio and video quality at the respective devices during the video conferencing session, and adapting the respective communication parameters based on changes to the respective measures of audio and video quality determined based on the monitoring. For example, the adapting can comprise re-allocating network resources of the communication network used to communicate the respective data streams in accordance with the respective communication parameters.

In some aspects, system can the respective audio-visual parameters as a function of a context of the video conferencing session and relative priorities of the respective audio-visual parameters with respect to the context. For example, the respective audio-visual parameters can comprise an audio quality parameter of audio data of the data streams and a video quality parameter of video data of the data streams, and wherein the determining the respective audio-visual parameters comprises enhancing the audio quality parameter relative to the video quality parameter based on the context indicating the audio quality parameter has a higher priority relative to the video quality parameter. Additionally, the system can determine the respective audio-visual parameters a function of a context of the video conferencing session and respective preferences of the participants. In some embodiments, in association with determining the respective audio-visual parameters, the operations can comprise selecting background image content for rendering at the devices based on the context of the video conferencing session, and wherein the controlling further comprises controlling the rendering of the background image content at the devices during the video conferencing session.

In some implementations, determining the respective audio-visual parameters comprises determining an audio filter or a video filter to apply to a data stream of the respective data streams based on a context of the video conferencing session and a preference associated with a participant identity of a participant in the video conferencing session and associated with the data stream, and wherein the controlling comprises applying the audio filter of the video filter to the data stream.

In some implementations, the operations can further comprise detecting a rendering delay of a data stream of the respective data streams at a device of the devices, selecting image data or audio data associated a participant identity of a participant in the video conferencing session and associated with the data stream, and controlling rendering of the image data or the audio data at the device in association with the rendering delay.

The operations can further comprise analyzing audio-visual data of the respective data streams during the video conferencing session, detecting events associated with the video conferencing session based on the analyzing, and adapting the respective audio-visual parameters based on the events. In some implementations, the operations can further comprise monitoring eye movement of the participants of the video conferencing session, and controlling capture of image data of the respective data streams as a function of the eye movement.

Generally, reference to an “entity”, “user”, or “participant,” is used herein to refer to a person/human being. However, the term “entity” as used herein can refer to a person, a group of people (e.g., including two or more), an animal, a machine/device or group of machines/devices. An entity can be represented by a user profile or account that can be associated with one or more systems and/or devices. The terms “algorithm” and “model” are used herein interchangeably unless context warrants particular distinction amongst the terms. The terms “artificial intelligence (AI) model” and “machine learning (ML) model” are used herein interchangeably unless context warrants particular distinction amongst the terms.

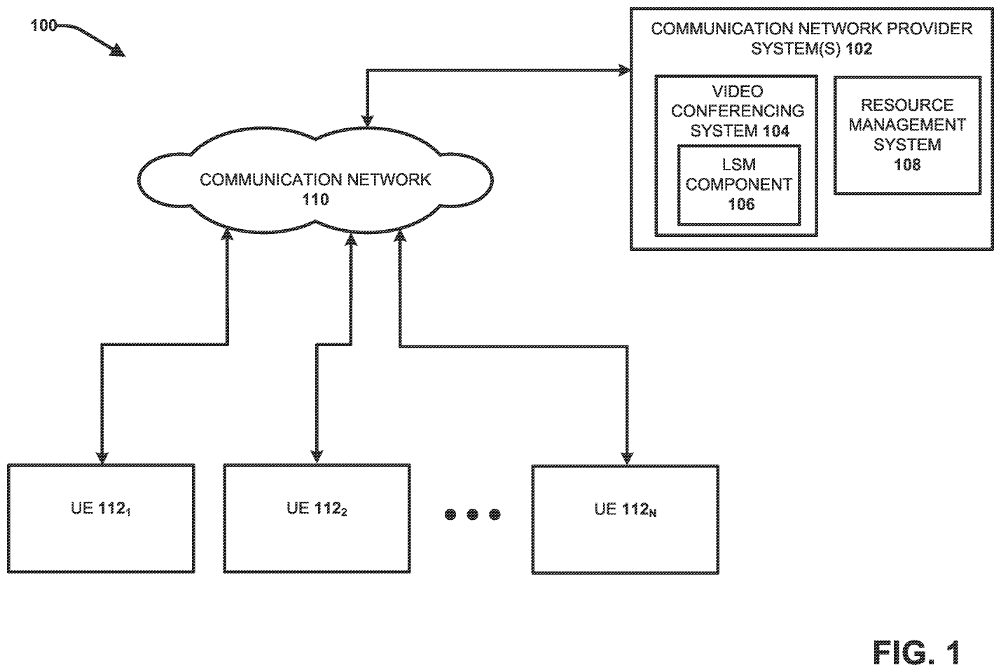

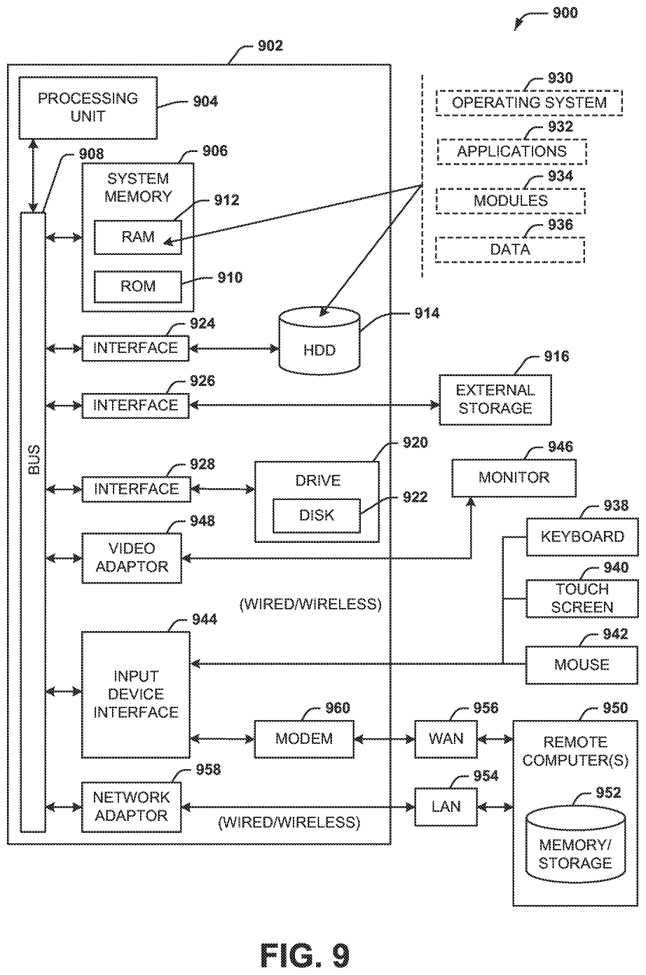

Embodiments of systems and devices described herein can include one or more machine-executable components or instructions embodied within one or more machines (e.g., embodied in one or more computer-readable storage media associated with one or more machines). Such components, when executed by the one or more machines (e.g., processors, computers, computing devices, virtual machines, etc.) can cause the one or more machines to perform the operations described. These computer/machine executable components or instructions (and other described herein) can be stored in memory associated with the one or more machines. The memory can further be operatively coupled to at least one processor, such that the components can be executed by the at least one processor to perform the operations described. In some embodiments, the memory can include anon-transitory machine-readable medium, comprising the executable components or instructions that, when executed by a processor, facilitate performance of operations described for the respective executable components. Examples of said and memory and processor as well as other suitable computer or computing-based elements, can be found with reference to FIG. 9 (e.g., processing unit 904 and system memory 906 respectively), and can be used in connection with implementing one or more of the systems or components shown and described in connection with FIG. 1, or other figures disclosed herein.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details. In additional, it should be appreciated that various illustrations and system configurations are exemplary and not drawn to scale.

Turning now to the drawings, FIG. 1 illustrates an example, high-level architecture diagram of a non-limiting system 100 that facilitates intelligent management of adaptable audio-visuals of cloud-based video conferencing sessions in accordance with one or more embodiments of the disclosed subject matter. System 100 includes a video conferencing system 104 that corresponds to a cloud-based or web-based video conferencing system that provides video conferencing services to users via a communication network 110 in association with usage of respective user equipment (UE 112_{1-N}) by the users. In this regard, the UE 112_{1-N} can correspond to respective participant devices or equipment of participants of a video conferencing session.

The number and type of participant devices (e.g., UE 112_{1-N}) can vary so long as the participant devices correspond to computing devices with suitable communication hardware/software for connecting to the communication network 110 and comprise suitable hardware and software for performing web-based video conferencing. In this regard, the hardware required for performing a video conferencing session includes at least one display monitor, at least one microphone, at least one camera, and at least one speaker. It should be appreciated that the respective UE 112_{1-N} comprise this hardware. For example, the participant devices (e.g., UE 112_{1-N}) can include smartphones, tablets, laptops, desktops, Internet-enabled televisions, multi-monitor systems, video conferencing systems, telepresence systems, and others. The audio-visual capabilities of the participant devices (e.g., UE 112_{1-N}) can vary. In some embodiments, one or more of the participant devices UE 112_{1-N} can include or be communicatively coupled to a plurality (e.g., two or more) of cameras, display monitors, microphones and speakers. For example, in some implementations, one or more of the UE 112_{1-N} can include or correspond to a local video conferencing system deployed in a conference room, meeting room, or the like, adapted to facilitate a mixed video conferencing session including individual remote participants and a group of in-person participants located in the conference room. With these embodiments, the local video conferencing system may include multiple cameras, microphones, speakers, etc. positioned at different viewpoints withing the conference room.

In some embodiments, the non-limiting term user equipment (UE), communication device (or a similar term) is used. It can refer to any type of wired or wireless device that can communicate with another communication device in a wired or wireless communication system via one or more communication networks (e.g., communication network 110). In this regard, communication devices (e.g., UE 112_{1-N}) can communicate information (e.g., audio-visual data traffic) to other communication devices via the communication network 110, which can comprise a core network that can operate to enable wireless communication between communication devices. For example, a wireless communication device (e.g., a mobile, cell or smart phone, an electronic tablet or pad, a personal computer, or another type of communication device) can connect to and communicate with a wireless communication network to communicate with another communication device connected to the wireless communication network or to another communication network (e.g., Internet Protocol (IP)-based network, such as the Internet) associated with (e.g., communicatively connected to) the wireless communication network. Communication devices can operate and communicate via wireless or wireline communication connections (e.g., communication links or channels) in a communication network to perform desired transfers of data (e.g., audio-visual data), utilize services, engage in transactions or other interactions, and/or perform other operations.

In this regard, the communication network 110 can comprise but is not limited to, one or more wired and wireless networks, including, but not limited to, a cellular or mobile network, a wide area network (WAN) (e.g., the Internet), a local area network (LAN), and combinations thereof. Such networks can include Universal Mobile Telecommunications System (UMTS) networks, Long-Term Evolution (LTE) networks, Third Generation Partnership Project (3GPP) networks (or 3G), Fourth Generation (4G) networks, Fifth Generation (5G) networks, Sixth Generation (6G) networks (and beyond), Code Division Multiple Access (CDMA) networks, Wi-Fi networks, Worldwide Interoperability for Microwave Access (WiMAX) networks, General Packet Radio Service (GPRS) networks, Enhanced GPRS, Ultra Mobile Broadband (UMB), High Speed Packet Access (HSPA), Evolved High Speed Packet Access (HSPA+) networks, High-Speed Downlink Packet Access (HSDPA) networks, High-Speed Uplink Packet Access (HSUPA) networks, Zigbee networks, or another IEEE 802.XX technology networks. Additionally, substantially all aspects disclosed herein can be exploited in legacy telecommunication technologies. Further, the various aspects can be utilized with any Radio Access Technology (RAT) or multi-RAT system where the mobile device operates using multiple carriers (e.g., LTE Frequency Division Duplexing (FDD)/Time-Division Duplexing (TDD), Wideband Code Division Multiplexing Access (WCMDA)/HSPA, Global System for Mobile Communications (GSM)/GSM EDGE Radio Access Network (GERAN), Wi Fi, Wireless Local Area Network (WLAN), WiMax, CDMA2000, and so on), and satellite networks.

The communication network 110 can be associated with a single network provider, multiple network providers, and/or encompass a variety of different type of wired and wireless communication technologies (e.g., 3GGP, WiFi, LTE, satellite, 5G, etc.) and sub-networks. In some embodiments, the communication network provider systems 102 can comprise computing systems that are owned/operated and/or controlled by the one or more communication network providers. For example, in some implementations, the one or more communication network provider may correspond to a telecommunications service provider/carrier that provides a wide range of different types of telecommunication services to different types of communication devices via one or more communication networks (e.g., communication network 110) and sub-networks comprised of network equipment/resources owned/operated by the telecommunication service provider. The types of services can vary depending on the network capabilities and communication technologies supported by the communication network (e.g., cellular 3G, 4G, 5G, Wi-Fi, satellite, etc.) and the features and functionalities of the respective communication devices. For example, as applied to advanced communication network providers providing New Radio/5G communication networks and beyond, the types services can relate to, for example, audio-video streaming, video calls, video content, audio streaming, audio calls, audio content, electronic gaming, education, text messaging, multimedia messaging, emails, website content, utility information (e.g., utility information from smart meters), emergency-related information, military-related information, law enforcement-related information, fire response services-related information, disaster response services-related information, and/or other desired types of information, content, or activities. As applied to the disclosed subject matter, in some embodiments the communication services can also include disclosed the web-based video conferencing services performed or facilitated by the video conferencing system 104 using a lead session management component (LSM component 106).

With these embodiments, the communication network provider can control provision of communication services to respective communication devices via the communication network 110 in accordance with established communication service agreements (e.g., customer/user subscription agreements/plans) associated with the respective communications devices and their users. For example, the communication service provider can maintain customer/subscriber account information for all subscribed users that uniquely identifies each subscriber of the network (e.g., via username/account information) and uniquely identifies their associated communication device or devices (e.g., via unique device identifiers) authorized to employ the communication network 110 (e.g., including UE 112_{1-N}). In accordance with system 100, the communication network service provider systems 116 can include one or more systems and/or databases that maintain or otherwise provides access to such subscriber information for the communication service provider. The communication service provider can also maintain additional information regarding respective communication devices subscribed to or otherwise connected to the communication network 110, including but not limited to, device location information (e.g., including fixed location devices and mobile device locations) and device capability information. In other embodiments however, the video conferencing system 104 may be disassociated with the communication network provider and/or the communication network provider system 102.

In some embodiments, the non-limiting term network equipment (NE), network device, and network node are used herein. These terms may be used interchangeably and refer to any type of physical resource (e.g., devices, computers, processors, switches, cables, data storage devices, routers, etc., including virtualized devices, computers, processors, switches, cables, data storage devices, routers) of the communication network 110, which can vary depending on the type or types of wired and wireless communication technologies (e.g., 3G, 4G, LTE, 5G, Wi-Fi, satellite, etc.) employed by the communication network 110. In this regard, the NE can include or be associated with physical and logical (e.g., software defined) network components or resources of the communication network 110 that provide essentially any network provider controlled function of the communication network 110, including network access related functions, data transport related functions, and network core processing functions.

For example, in various embodiments, the communication network 110 can comprise a distributed network architecture including a plurality of different network resources distributed between an access network layer, a transport layer and a network core layer. These network resources can include physical resources (e.g., devices, hardware, etc.) as well as logical resources (e.g., radio frequency spectrum resources, data processing resources, etc.). The access network layer controls connection and access of communication devices and systems (e.g., UE 112_{1-N}) one or more communication network provider systems 102) to the communication network 110 via one or more physical network access points (APs). The network access layer usually incorporates Layer 2 switches and access point devices that provide connectivity between workstations and servers. In this regard, the NE can include physical access point (AP) devices, system, and/or sub-networks that control physical connectivity of communication devices to the communication network 110. The logical network resources associated with the access layer can include a variety of different software defined tools that control logical access to the network, such as tools for managing access control with respect to network policies and security (e.g., credentials, validation, authorization, etc.). These components can enforce access control measures for systems, applications, processes and information. For example, the logical network resources associated with the access layer can manage access control and policy, create separate collision domains, and implement port security.

The types of the physical APs can vary and can include a variety of different types of access points devices/systems that employ a variety of different types of wired and wireless communication access technologies (e.g., 3G, 4G, LTE, 5G, Wi-Fi, satellite, etc.) employed by the communication network 110. Depending on the type of the APs, the APs may be standalone AP devices or part of separate communication networks (e.g., satellite communication networks, mobile communication networks, cellular communication networks, multi-carrier communication networks, etc.). For example, in various embodiments, the communication network 110 can include a cellular communication network that employs a RAN architecture. The cellular communication network can correspond to a 5G network, an LTE network, a 3G network or another type of cellular technology communication network. The RAN can comprise various network components or devices, which can include one or more RANs, wherein each RAN can comprise or be associated with a set of base stations located in respective coverage areas served by the respective base stations. The respective base stations can be associated with one or more sectors (not shown), wherein respective sectors can comprise respective cells. The cells can have respective coverage areas that can form the coverage area covered by the one or more sectors. Communication devices can be communicatively connected to the cellular communication network via respective wireless communication connections with one or more of the base stations. In this regard, examples of NE corresponding to radio network nodes are Node B, base station (BS), multi-standard radio (MSR) node such as MSR BS, gNodeB, eNode B, access point (AP) devices, network controller, radio network controller (RNC), base station controller (BSC), relay, donor node controlling relay, base transceiver station (BTS), transmission points, transmission nodes, radio resource unit (RRU), remote radio head (RRH), nodes in distributed antenna system (DAS), etc.

In some embodiments, the one or more RANs can be based on open-RAN (O-RAN) technology and standards. These standards can define the open interface that can support interoperability of network elements (e.g., radio unit (RU), central unit (CU), distributed unit (DU), real or near real time RAN intelligent controller (RIC), or other types of network elements from different entities (e.g., vendors). The network elements may be virtualized, e.g., software-based components that can run on a common virtualization/cloud platform. In certain embodiments, the O-RAN based RAN can utilize a common platform that can reduce reliance on proprietary platforms of service providers. The O-RAN based RAN also can employ standardized interfaces and application programming interfaces (APIs) to facilitate open source implementation of the O-RAN based RAN.

In some embodiments, the one or more RANs can be a cloud-based radio access network (C-RAN). A C-RAN is a deployment paradigm that seeks to isolate baseband unit (BBU) from its remote radio unit (RRU) in base station (BS), consolidating the BBUs into a common place referred to as the BBU pool. In the BBU pool, the computing resources provided by the BBUs can be dynamically assigned to RRUs on demand by the BBU controller. Thus, with the fluctuation of data traffic from RRUs, a part of BBUs can be dynamically turned on or off.

The network transport layer serves as the communication point between the access layer and the network core where the communication network provider systems 102 typically reside. Its primary functions are to provide routing, filtering, and quality of service (QoS) management and to determine how packets can access the core. For example, the NE 104 can also include physical network resources associated with the transport layer, which usually consists of routers, routing systems, and multilayer switches. Logical network resources associated with the transport layer can include computer-executable components that can determine and control the most efficient way that network service requests are accessed—for example, how a file request is forwarded to a server—and, if necessary, forwards the request to one or more network resources associated with the network core layer.

The core layer of the communication network 110, also referred to as the network backbone, is responsible for transporting large amounts of traffic quickly. The core layer provides interconnectivity between the transport layer devices. The physical and logical network resources associated with the core layer can vary depending on the architecture of the communication network. Next generation or 5G cellular networks are implementing substantially software defined network core elements. The network core typically provides key Evolved Packet Core functions including the Mobile Management Entity (MME), the Serving Gateway (S-GW), the Packet Data Network Gateway (PDN-GW), the Home Subscriber Server (HSS), a Policy Control Rules Function (PCRF), an Access and Mobility Management Function (AMF), a User Plane Function (UPF), and others. The network core layer may include high speed NE devices, like high end routers and switches with redundant links.

In accordance with various embodiments, the communication network provider systems 102 can correspond to network systems associated with the network core layer of the communication network 110 (however other configurations are envisioned). Respective systems (and/or components thereof) of the communication network provider system 102 (e.g., the video conferencing system 104, the resource management system 108, and various additional systems) can be communicatively and/or operatively coupled via any suitable wired or wireless communication technology. In some embodiments, the resource management system 118 can control the allocation and distribution of resources of the communication network 110 in association with performing communication services provisioned by the communication network 110. These communication services can include the video conferencing services provided by and/or facilitated by the video conferencing system 104 and the LSM component 106, as discussed in greater detail below.

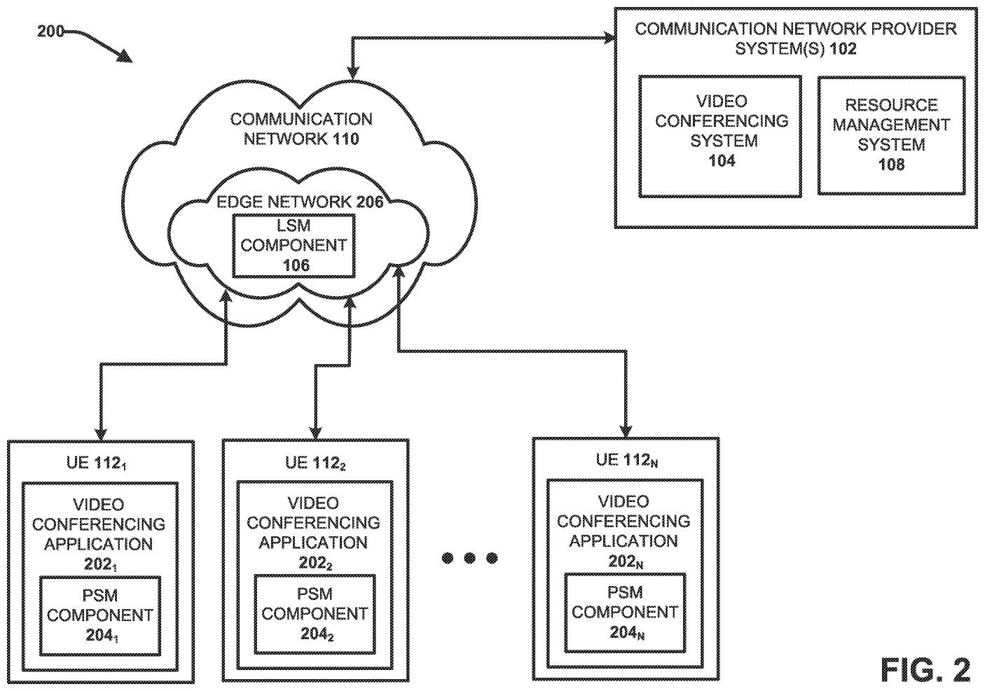

FIG. 2 illustrates another example, high-level architecture diagram of a non-limiting system 200 that facilitates intelligent management of adaptable audio-visuals of cloud-based video conferencing sessions in accordance with one or more embodiments of the disclosed subject matter. System 200 demonstrates an additional architectural configuration that can be employed by the video conferencing system 104 to facilitate intelligent management of adaptable audio-visuals of cloud-based video conferencing sessions in accordance with one or more embodiments of the disclosed subject matter.

In this regard, with reference to FIGS. 1 and 2, in some embodiments, the video conferencing system 104 can employ a web-application platform (or the like) to provide video conferencing services to users via their respective participant devices (e.g., UE 112_{1-N}). With these embodiments, the respective participant devices (e.g., UE 112_{1-N}) can access and employ the video conferencing services provisioned by the video conferencing system 104 using a suitable browser. Additionally, or alternatively, the video conferencing system 104 an provide video conferencing services to participant devices using a mobile-application, client-application, thin-client application, hybrid-client application, etc., type of deployment architecture, as illustrated in FIG. 2. With these embodiments, the one or more of participant devices (e.g., UE 112_{1-N}) can include local video conferencing applications 202_{1-N}. The video conferencing applications 202_{1-N} can facilitate performance of video conferencing services provisioned by the video conferencing system 104 via the communication network 110. In some embodiments, the video conferencing applications 202_{1-N} can include a local participant version of the LSM component 106, represented in system 200 as a participant session manager (PSM) components 204_{1-N}. With these embodiments, the PSM components 202_{1-N} can perform same or similar functions as the LSM component yet tailored to specifically optimizing one or more audio-visual parameters or settings of the corresponding participant device. For example, the PSM components 202_{1-N} can determine, apply and/or adapt one or more audio-visual parameters and/or settings at a participant device in an automated manner as discussed with reference to the LSM component 106. The PSM components 202_{1-N} can further coordinate and communicate with the LSM component 106 to facilitate harmonizing the audio-visual parameters of the participant devices with one another in a manner that balances the experience for all devices collectively. For example, in various embodiments, the PSM components 202_{1-N} can determine and communicate capabilities information to the LSM component 106 indicating the UE audio-visual capabilities and network connection capabilities. The PSM components 202_{1-N} can also communicate audio-visual settings information to the LSM component 106 identifying or indicating one or more audio-visual settings or parameters determined and/or applied by PSM components 202_{1-N} to their corresponding UE 112_{1-N} in association with performing a video-conferencing session. With these embodiments, the LSM component 106 can work with the respective PSMs 202_{1-N} in a coordinated manner to facilitate optimizing and adapting audio-visual settings or parameters of the video-conferencing session.

System 200 further demonstrates and edge-computing architectural deployment configuration of the LSM component 106. In accordance with configuration, the communication network 110 can include an edge network 206 that corresponds to an edge, sub-network of the communication network 110. The edge network 206 can include one or more edge nodes comprising one or more edge servers and one or more edge databases. Edge networks can host applications (e.g., video conferencing applications) and application components (e.g., LSM component 106 and/or one or more components thereof) at the edge servers. Edge computing is a distributed computing paradigm which brings computation and data storage closer to a location where it is needed, to improve response times and save bandwidth. Modern edge computing significantly extends this approach through virtualization technology that makes it easier to deploy and run a wide range of applications on the edge servers.

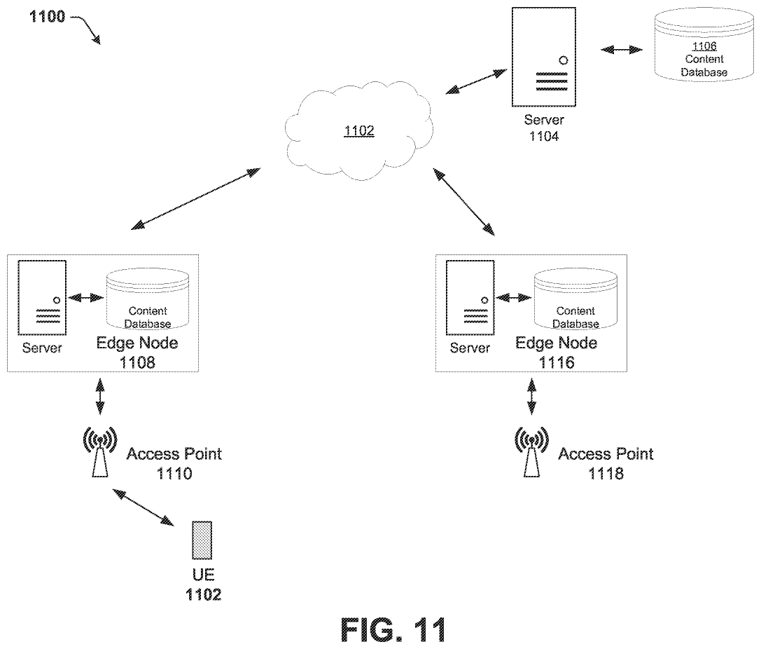

Devices at the edge can consume data coming from the cloud, forcing companies to build content delivery networks to decentralize data and service provisioning, leveraging physical proximity to the end user. In a similar manner, the aim of edge computing is to move the computation away from data centers towards the edge of the network, exploiting smart objects, mobile phones, or network gateways to perform tasks and provide services on behalf of the cloud. By moving services to the edge, it is possible to provide content caching, service delivery, storage and Internet of things (IoT) management resulting in better response times and transfer rates. An example edge network that may be employed by system 200 and edge network 206 is described with reference to FIG. 11.

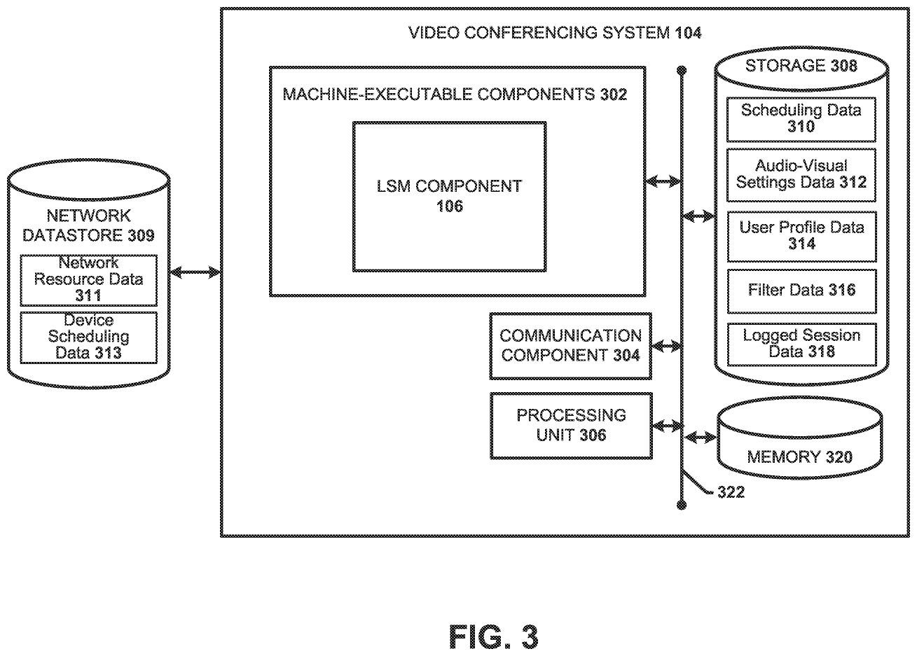

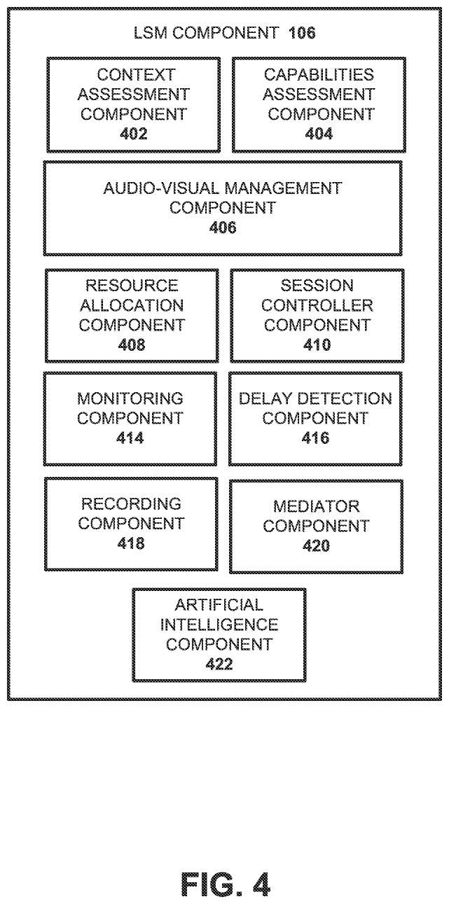

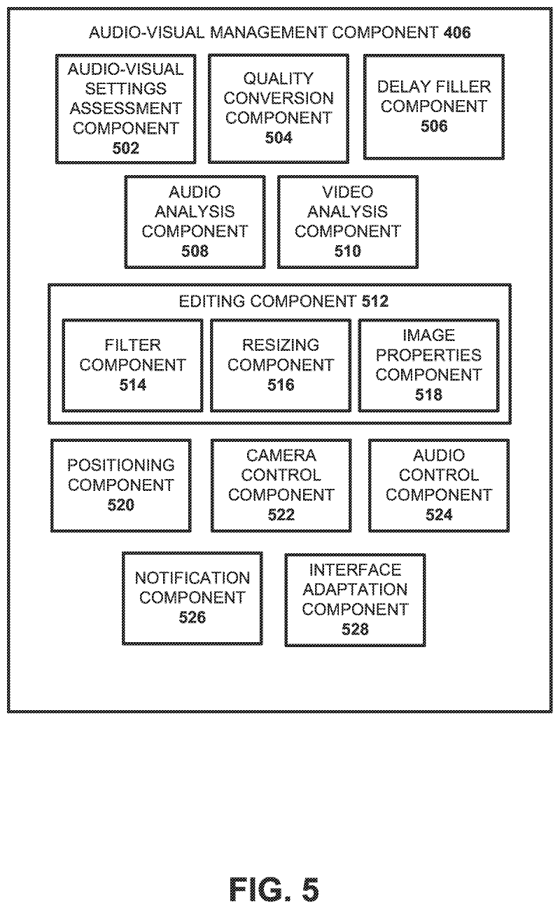

FIG. 3 presents an example video conferencing system 104 in accordance with one or more embodiments of the disclosed subject matter. The video conferencing system 104 includes machine-executable components 302, which includes the LSM component 106 and its corresponding sub-components illustrated in FIGS. 4 and 5. The video-conferencing system 104 further includes storage 308, communication component 304, processing unit 306 and memory 320. The video conferencing system 104 further includes a system bus 322 that couples the machine-executable components 302, the storage 308 the communication component 304, the processing unit 306 and the memory 320 to one another. In some embodiments, machine-executable components 302 can be stored in memory 320 and executed by the processing unit 306 to cause the video conferencing system 104 to perform operations described with respect to the corresponding components. In this regard, the video conferencing system 104 can correspond to any suitable computing system, device or machine (e.g., a communication device, a server device, an edge-server device, a desktop computer, a personal computer, a smartphone, a virtual computing device, a processor, etc.), or interconnected group of computing systems, devices, and/or machine (e.g., interconnected via wired and/or wireless communication technologies).

In some embodiments, memory 320 can comprise volatile memory (e.g., random access memory (RAM), static RAM (SRAM), dynamic RAM (DRAM), etc.) that can employ one or more memory architectures. Further examples of memory are described below with reference to system memory 904 of FIG. 9 discussed below. In some embodiments, storage 308 can comprise non-volatile memory (e.g., read only memory (ROM), programmable ROM (PROM), electrically programmable ROM (EPROM), electrically erasable programmable ROM (EEPROM), etc.) that can employ one or more storage architectures. Such examples of memory 320 and storage 308 can be employed to implement any embodiments of the subject disclosure described or suggested by disclosures herein.

According to multiple embodiments, the processing unit 306 can comprise one or more processors and/or electronic circuitry that can implement one or more computer and/or machine readable, writable, and/or executable components and/or instructions that can be stored using memory 320 and storage 308. For example, the processing unit 306 can perform various operations that can be specified by such computer and/or machine readable, writable, and/or executable components and/or instructions including, but not limited to, logic, control, input/output (I/O), arithmetic, and/or the like. In some embodiments, processing unit 306 can comprise one or more central processing unit, multi-core processor, microprocessor, dual microprocessors, microcontroller, System on a Chip (SOC), array processor, vector processor, and/or another type of processor. Further examples of the processing unit 306 are described below with reference to processing unit 904 of FIG. 9 below. Such examples of the processing unit 904 can be employed to implement any embodiments of the subject disclosure.

The storage 308 can store a variety of information that is received by, used by, and/or generated by the video conferencing system 104 in association with providing video conferencing services with adaptable audio-visuals in accordance with various aspects and embodiments of the disclosed subject matter. In the embodiment, shown, this information includes (but is not limited to), scheduling data 310, audio-visual settings data 312, user profile data 314, filter data 316 and logged session data 318. The video conferencing system 104 can also be communicatively coupled (e.g., via wired and/or wireless communication technologies) to various external databases and/or systems that can provide information that can be used by the video conferencing system 104 in association with determining and controlling audio-visual parameters of a video conferencing session in accordance with various aspects and embodiments of the disclosed subject matter. In the embodiment shown, these databases include network datastore 309 providing network resource data 311 and device scheduling data 313. The network datastore 309 can correspond to any suitable machine-readable media that can be accessed by the video conferencing system 104 and includes both volatile and non-volatile media, removable and non-removable media implemented in any method or technology for storage of information, such as computer-readable instructions, data structures, models, algorithms, program modules, or other data. Computer storage media can include, but is not limited to, random access memory (RAM), read only memory (ROM), erasable programmable read only memory (EPROM), flash memory or other memory technology, digital video disk (DVD) or other optical disk storage, magnetic cassettes, magnetic tape, magnetic disk storage or other magnetic storage devices, or any other medium which can be used to store the desired information and which can be accessed by the video conferencing system 104.

The communication component 304 can correspond to any suitable communication technology hardware and/or software that can perform wired and/or wireless communication of data between the video conferencing system 104 and other systems, devices and/or data storage media. In this regard, the communication component 304 can provide for receiving data from one or more external systems and/or devices (e.g., UE 112_{1-N}, NE of the communication network 110, edge nodes of the edge network 206, resource management system 108, and other systems/devices) and communicating (e.g., sending, transmitting, etc.) data to one or more external systems and/or devices. The communication component 304 can also provide for accessing information/data located at one or more external devices, systems and/or storage media (e.g., network datastore 309). Examples of suitable communication technology hardware and/or software employable by the communication component 930 are described infra with reference to FIG. 9.

FIG. 4 presents an example LSM component 106 in accordance with one or more embodiments of the disclosed subject matter. With reference to FIGS. 1-4, the LSM component 106 can provide for automatically determining, applying and adapting various audio and visual parameters or settings of a videoconferencing session in real-time to optimize the experience for individual participants while harmonizing the experience for all participants. In this regard, the LSM component 106 corresponds to an intelligent manager that determines and controls how participants' audio-visual data stream content looks and sounds to one another at their respective participant equipment over the course of the session. In association with initiation of a video conferencing session, the LSM component 106 can facilitate determining and applying the optimal or improved audio-visual settings for all (or some) participants of the session that accounts for the respective audio-visual and network connection capabilities of the respective devices, the context of the session, and user preferences of the participants (e.g., provided the user profile data 312). The LSM component 106 further actively monitors the session and adapts the audio-visual parameters over the course of the session as needed to account for changes in network conditions (e.g., of the communication network 110) and various other events that occur over the course of the session in a manger that optimizes the experience for the participants individually and collectively.

To facilitate this end, the LSM component 106 can include various machine-executable components that can perform various operations that facilitate intelligent management of adaptable audio-visuals of video conferencing sessions. These components include context assessment component 402, capabilities assessment component 404, audio-visual management component 406, resource allocation component 408, session controller component 410, monitoring component 414, delay detection component 416, recording component 418, mediator component 420 and artificial intelligence component 422. In some embodiments, the PSM components 204_{1-N} can correspond to local participant device version of the LSM component 106 and include one or more corresponding participant versions of the context assessment component 402, the capabilities assessment component 404, the audio-visual management component 406 (and/or sub-components thereof shown in FIG. 5), the resource allocation component 408, the session controller component 410, the monitoring component 414, delay detection component 416, the recording component 418, the mediator component 420 and the artificial intelligence component 422 With these embodiments, the respective components can perform same or similar functions as described with respect to the LSM component 106 yet tailored to specifically optimize the audio-visual parameters and settings automatically at the respective participant devices at which they are deployed, with some distinctions noted where applicable. Repetitive description of these components as deployed as the participant devices is omitted for sake of brevity.

In one or more embodiments, in association with initiation of a video conferencing session, the context assessment component 402 can assess the context and configuration of the video conferencing session. In this regard, the context assessment component 402 can identify and register the participants of the session (e.g., number of participants and identities of the participants) and the devices (e.g., UE 112_{1-N}) employed by the respective participants to perform the video conferencing session. In implementations in which the session involves a mixed videoconference including individual remote participants and a group of in-person participants located in the same physical room, the context assessment component 402 can further classify the group as a participant group, determine and register the respective in-person participants included in the group, and determine the device or devices employed by the participant group to perform the session.

The context assessment component 402 can also determine or infer (e.g., using artificial intelligence component 422) various relevant contextual information about the video conferencing session regarding the type of the video conferencing session and the type of user interaction to be captured and conveyed during the session. For example, the video conferencing session can include a wide range of different types of sessions, such business-related sessions or meetings, social related sessions, and events such as fitness classes, concerts, webinars, stand-up or improv shows, music lessons and various others. In various embodiments, the particular audio-visual settings that are applied for a video-conferencing session can be tailored for different types of sessions, as discussed in greater detail below. In some embodiments, the context assessment component 402 can determine or infer (e.g., using artificial intelligence component 422) the type of the session based on the participant identities, the number of participants, the time of the session and historical session data (e.g., included in logged session data 318) for the same or similar group of participants. In some embodiments, information regarding the type of the session and/or the type of audio-visual data that will be communicated during the session can be included in scheduling data 310 used to schedule the video conferencing session (e.g., in association with scheduling a video conferencing meeting, the host and/or one or more participants can provide information describing the type and context of the meeting/session). In some embodiments, the context component 402 can also determine information regarding the respective locations of the participant devices and their mobility states (e.g., stationary or mobile, and if mobile, speed and route information). The context component 402 can also determine or infer (e.g., using artificial intelligence component 422) the context or nature of the session based on the respective locations of the devices, their respective mobility states and past session data correlating the participants, the participant devices and/or the locations and mobility state combination to one or more session types and contexts.

The capabilities assessment component 404 can also determine respective capabilities of the participant devices (e.g., UE 112_{1-N}) in association with initiation of the video conferencing session, including audio-visual capabilities and network connection capabilities of the respective devices. The audio-visual capabilities can account for both the audio-visual hardware and software capabilities of the participant devices, which can vary for different types of devices. For example, the participant devices can include smartphones, tablets, laptops, desktops, Internet-enabled televisions, multi-monitor systems, video conferencing systems, telepresence systems, and others. The hardware required for performing a video conferencing session includes at least one display monitor, at least one microphone, at least one camera, and at least one speaker. In various embodiments, the capabilities assessment component 404 can determine the type of audio-visual equipment employed by the respective participant devices to perform the session, including the type of equipment, the number of equipment components (e.g., number of cameras, number of speakers, number of microphones), and the audio-visual capabilities of the respective equipment components. In this regard, each of these hardware components can have different capabilities with respect to audio and/or video data capture quality and/or rendering quality. In various embodiments, the audio-visual capabilities assessment can include determining information regarding the quality of audio and video capable of being captured and streamed by the respective devices and the quality of audio and video capable of being rendered at the respective devices. For example, the video quality capture and rendering capabilities can include the maximum and minimum capture and rendering resolution capabilities of image/video data of the respective camera and displays of the participant devices. The capabilities assessment component 404 can also determine the display dimensions. The audio capabilities of the respective microphone and speakers of the participant devices can include one or more measure of input and output power, frequency response, signal-to-noise ratio, total harmonic distortion, sensitivity and impedance.

In some embodiments, the capabilities assessment component 404 can perform or facilitate performing an audio and video performance assessment check with the participant devices at the initiation of a session to determine the audio and video capabilities of the respective devices. The sound and video check can also be used to determine whether audio and/or video is turned on/off for any of the participant devices and the baseline capture and rendering quality settings of the audio-visual equipment. In association with performing the capabilities assessment, the capabilities assessment component 404 can also determine volume and mute settings of the participant devices.

The network connection capabilities information can include information regarding the data communication performance capabilities of the respective participant devices (e.g., UE 112_{1-N}) communication links to the communication network 110 employed to perform the video conferencing session (e.g., the Internet, a cellular network and/or other types of communication networks). In this regard, the network connection capabilities information can include information regarding the type of the access connection or communication link to the communication network 110 (e.g., wired, wireless, Wi-Fi, fiber, cellular LTE, cellular 5G, etc.), the connection speed (e.g., the uplink (UP) and downlink (DL) speed), the connection bandwidth, the connection stability, the connection latency, the connection reliability, the connection load, and so on. In some embodiments, one or more of the participant devices can be connected to the communication network 110 via NE provisioned by the same provider of the video conferencing system 104. With these embodiments, the resource management system 108 can maintain network resource data 311 and device scheduling data 313 for the network that tracks and monitors the respective network connections and communication link scheduling parameters for all devices connected to the network and the capabilities assessment component 404 can determine the connection capabilities as included in the network datastore 309. In implementations in which one or more participant devices are connected to the network via third-party communication service provider equipment, the capabilities assessment component 404 can determine network connection capabilities information for these devices using alternative mechanism. For example, in some implementations, these participant devices can provide their network capabilities information to the LSM component 106 in association with performing an UL speed and DL speed test and other type of connectivity assessment tests at the initiation of the session. In some implementations in which the one or more participant devices include a PSM component 204, the PSM component 204 can perform the connectivity test assessment in association with initiation of the session and provide the results to the LSM component 106. For example, the PSM component 204 can respectively correspond to local instances of the LSM component 106 and include a capabilities assessment component 404 that performs a same or similar capabilities assessment for the corresponding participant device at which it is deployed. Various other suitable mechanism for assessing network connectivity performance measure are envisioned.

The audio-visual management component 406 can further determine and manage respective audio-visual parameters and settings of the video conferencing session applicable to the respective devices as a function of the capabilities of the respective devices, the context of the session, preferences of the participants and other factors. The audio-visual management component 406 and/or the session controller component 410 can further control performance of the video conferencing session at the respective participant devices in accordance with the respective audio-visual parameters. In this regard, the audio-visual parameters and settings of the video conferencing session can relate to the quality of the audio and/or video data of the video-conferencing session and the audio and/or video content captured and/or rendered (or not capture/rendered) in association with the video conferencing session. In some implementations, the audio-visual parameters can also include volume levels. The mechanisms for determining, applying and adapting the parameters/setting can vary depending on the type of the parameter (e.g., quality related or content related), and the configuration of the system (e.g., system 100 and/or system 200).

FIG. 5 presents an example audio-visual management component 406 in accordance with one or more embodiments of the disclosed subject matter. The audio-visual management component 406 can include various machine-executable components, including audio-visual settings assessment component 502, quality conversion component 504, delay filler component 506, audio analysis component 508, video analysis component 510, editing component 512, positioning component 520, camera control component 522, audio control component 524, notification component 526, and interface adaptation component 528.

With reference to FIGS. 1-5, in one or more embodiments, in association with initiation of a video conferencing session, the audio-visual settings assessment component 502 can determine optimal, improved, or preferred measures of audio and video quality of audio and video data components of respective data streams to be rendered by the respective participant devices. The rendering quality of the audio and video content of a video conferencing session is multifactorial and based on the quality of the respective audio-visual capture equipment of the respective participant devices (e.g., microphones, cameras, web-cameras, etc.), the rendering quality capabilities of the respective participant devices (e.g., speakers, display devices/monitors), the audio-image data processing capabilities of the participant devices (e.g., codec and other processing capabilities), and the quality of the respective network connections and corresponding communications channels of the participant devices used to communicate the respective data streams between the participant devices (e.g., as a function of uplink (UL and downlink (DL) speeds and other communication performance metrics, which can vary as a function connection type (e.g., Wi-Fi, wired/wireless, fiber, cellular 3G, cellular LTE, cellular 5G, satellite, etc.), connection bandwidth, network load, channel quality, channel routing and path length, etc.). In this regard, there are complex relationships between the video quality, the amount of data used to represent the video (determined by the bit rate), the complexity of the encoding and decoding processes, sensitivity to data losses and errors, ease of editing, random access, and end-to-end delay (latency). For example, video bitrate is the video data transferred at a particular time. A high video bitrate is one of the most vital factors in the quality of a video. A good-looking video consists of a high video bitrate along with a high video resolution and framerate. Pixels define the resolution of the video, while bitrate is average data size for a video file expressed per second of video. There can be high-resolution videos with low bitrate and low-resolution videos at very high video bitrate, which is based on rendering processing that can be used to express what to display on a video with least amount of file size. These processes can force the bitrate for a video at any arbitrary small value while compromising on the quality.

In various embodiments, the audio-visual settings assessment component 502 can determine the optimal, improved, or preferred measures of audio (e.g., audio quality levels) and video quality (e.g., video quality levels and/or resolution levels) of audio and video data components of respective data streams to be rendered by the respective participant devices as a function of an assessment of the state of these multi-factors. In association with determining the optimal, improved, or preferred measures of audio and video quality, the audio-visual settings assessment component 502 can determine the optimal, improved, or preferred measures of audio and video quality for each of the participant devices that balance the respective audio-visual capabilities and network connection capabilities of the participant devices and accounts for their differences. For example, if there are three participants in a session, one of which has the best/highest definition audio-visual capabilities, the audio-visual settings assessment component 502 can balance the respective data stream rendering quality levels to ensure that everyone has a similar experience (and without quality degradation). In another example, if there are three participants in a session, one of which has a poor network connection with low bandwidth for sending and receiving high-definition audio/video data, the audio-visual settings assessment component 502 can balance the respective data stream quality levels to ensure that everyone has a similar experience (and without quality degradation).

In some embodiments, the quality conversion component 504 can also work with conflicting devices to adjust for audio-video processing capabilities (e.g., based on device ability to convert images from low-resolution to high resolution and vice versa). For example, some embodiments, the quality conversion component can perform data processing (e.g., converting audio and/or video from a first quality level to a second quality level, and vice versa) on one or more of the participants data streams as needed in real-time to balance out the audio-video quality prior to forwarding the data streams to the corresponding recipients. In this regard, the audio-visual settings assessment component 502 can optimize the audio-video data quality measure of respective data streams communicated between the participant devices based on their respective audio and video quality capture and rendering capabilities and their network connection capabilities, which can influence the rendering quality of the audio-video data streams at the respective devices.

The audio-visual settings assessment component 502 can further tailor the optimal or improved audio and video quality measures for the respective participant devices of session based on a context of the session, the type of audio-visual content expected to be streamed during the session, the relative importance of audio and video quality as a function of the context of the session, and relative difficulties associated with maintaining certain levels of audio and video quality as a function of the context of the session and user preferences. In this regard, the context of the session can reflect the type of session (e.g., a business/work conference, a social gathering, a musical performance, a fitness class, etc.), the number of participants, the identities of the participants, the locations of the participant devices, the mobility states of the participant devices, and various other factors. In this regards, different types of sessions can be associated with different audio and video quality requirements and demands. For example, the video quality demands of a video comprising live action of a sports event or theatrical performance may be higher than those of an educational seminar or small-scale (e.g., 3-5 participants) business meeting with minimal visual activity. Likewise, depending on network capabilities of the respective devices, the number of participating devices, and the locations of the devices, delivering audio and/or video with a lower quality may be necessary to minimize delays. In some implementations, audio quality may be more important than video quality, and vice versa, depending on the type of the session and the audio-visual content associated with the session.

In some embodiments, in association with determining the optimal, improved, or preferred audio-visual quality settings, the audio-visual settings assessment component 502 can employ predetermined audio-visual settings data 312 that defines optimal, improved, or preferred audio and video quality parameters for different types of sessions and session contexts. Additionally, or alternatively, the audio-visual settings assessment component 502 can employ ML and AI techniques (e.g., performed by the artificial intelligence component 422) to infer the optimal, improved, or preferred audio-visual quality settings based on analysis of logged session data 318. In this regard, the logged session data 318 can include information defining the audio-visual settings and parameters that were applied for past sessions of different types and under different contexts and performance metrics that reflect their impact on the overall quality of the experience of the session (e.g., session audio-video quality ratings, number of delays, frequency of delays, duration of delays, etc.). In some embodiments, the artificial intelligence component 422 can generate the audio-visual settings data 312 based on learned correlations in the logged session data 318 over time.

The LSM component 106 can further control performance of the video conferencing session to achieve the optimal, improved, or preferred audio and video quality measures determined for the session. For example, in some embodiments, the session controller component 410 can direct the respective participant devices to capture respective audio and video components at a specific audio and video quality levels (e.g., video resolution level and audio quality level) and render the respective audio and video components at specific audio and video quality levels, which may be lower than their maximum quality level capabilities. In some embodiments, the quality conversion component 504 can intercept and process one or more of the audio-visual data streams to convert the audio and/or video components thereof into a different format and/or quality level (e.g., from low definition to high definition or vice versa) prior forwarding to another device for rendering. In other embodiments, to corresponding PSM component version of the quality conversion component 504 deployed at a participant device can alternatively be directed (e.g., by the session controller component 410) to perform a particular audio-video data quality conversion on data streams prior to sending and/or rendering the data streams.

Additionally, or alternatively, the session controller component 410 can control the rendering quality of the audio and video components of the respective participant data streams as a function of controlling the allocation of network resources (e.g., physical and/or logical resources) of the communication network 110 used to communicate the respective data streams. In accordance with these embodiments, the resource allocation component 408 can determine an allocation of the network resource for communicating the audio-visual data streams between the respective participant devices via NE of the communication network 110 that results in achieving the optimal, improved, or preferred levels of audio and video quality as rendered at the participant devices. In some embodiments, this can involve determining and controlling communication parameters and settings of the communication network used to communicate the data streams between the respective devices (e.g., communication scheduling parameters/settings that control an UL rate and/or a DL rate of the respective audio-visual streams, such as but not limited to: a latency parameter, a reliability parameter, a routing parameter, a bandwidth parameter, and so on). The resource allocation component 408, in implementations in which UE have multiple simultaneous connections (e.g., different access connection mechanisms) and/or connection capabilities (e.g., switching from Wi-Fi to cellular), the resource allocation component 408 can direct the UE to use one connection over the other (e.g., if there are two edge locations, the network may suggest the UE stay on one verses the other edge location). To facilitate this end, the resource allocation component 408 can employ network resource data 311 comprising information identifying physical and logical resources of the communication network 110 and current allocations of the respective resources allocated by the communication network 110 in association with provisioning communication services to respective communication devices connected to the communication network 110, the communication devices including the video conferencing session participant device and other UE connected to the network). The resource allocation component 408 can also access and employ device scheduling information 313 that identifies current scheduling parameters used to communicate data between communication devices and the NE (e.g., base stations, routers, etc.) of the communication network 110 (e.g., wireless connection uplink/downlink parameters, transmission quality parameters, transmission rate parameters, reliability parameters, etc.). The resource allocation component 408 can further determine an allocation of the available network resources (e.g., logical and physical resources) for communicating the audio-visual data streams between the respective participant devices via NE of the communication network 110 that results in achieving the optimal, improved, or preferred levels of audio and video quality as rendered at the participant devices. The session controller component 410 can further direct the resource management system 108 to apply the determined allocation of network resources for the video conferencing session. In this regard, based on instructions received from the session controller component 410 identifying or indicating determined allocation of network resources for the respective participant devices of the session (e.g., communication scheduling parameters, and/or logical and/or physical resource assignments), the resource management system 118 can interface with the respective network resources to perform the allocation and scheduling. In another embodiments, the session controller component 410 can instruct the resource management system 118 regarding the optimal, improved, or preferred audio-visual rendering quality settings of the respective data streams of the video conferencing session and the resource management system 118 can determine and perform the appropriate resource allocation needed to achieve them over the course of the session.

In some embodiments, the monitoring component 414 can further monitor the respective audio-video data stream quality levels throughout the duration of the video conferencing session, which can be impacted changes in network conditions (e.g., load, interference, device mobility states, handovers, weather impacts, etc.) and events and occurrence over the course of the session. The resource allocation component 408 can further actively update and the allocation of network resources accordingly to maintain the optimal, improved, or preferred levels of audio and video quality for the session. changes in UL/DL rates, load, bandwidth, latency, etc.) and/or to otherwise improve video and audio quality within a room and virtually. As noted above, this can involve determining and controlling communication parameters and settings of the communication network used to communicate the data streams between the respective devices (e.g., controlling one or more of, an UL rate, a DL rate, a latency parameter, a reliability parameter, a routing parameter, and so on). For example, the monitoring component 414 and the resource allocation component 408 can monitor and adapt communication parameters and settings that control the resulting level of the quality of the data streams rendered by the respective devices in real-time to account for changes network conditions and communication channel issues that influence UL and DL rates (e.g., load) as well as changes device mobility (e.g., speed, handovers, etc.) in implementations in which one or more participant devices are mobile. In this regard, the LSM component 106 can find the appropriate “balance point” between all entities to ensure that the optimal, improved, voice and video quality remains in place for the duration of the meeting/gathering while accounting for changes in network conditions and connectivity capabilities of the respective devices.

In some embodiments, the delay detection component 416 can detect issues related to audio data and/or video data communication delays and errors that result in degraded quality of audio and/or video rendering at one or more participant devices, such as slowed audio/visual data rendering, pauses or gaps in audio/visual data rendering, and skipped or missed audio/visual data rendering. In some embodiments, the delay detection component 416 can predict communication delays ahead of time (e.g., at least 10 to 60 seconds) using a time/average prediction model and the resource allocation component 408 react accordingly to minimize the impact of the delays by adjusting one or more communication parameters and/or re-allocation network resource to minimize or prevent the delay and/or to otherwise counteract the resulting impact on audio-visual quality at the respective device.

In some embodiments, the audio-visual settings assessment component 502 can also adapt the quality levels of the respective audio-visual data streams to account for changes in network conditions and forecasted delays. For example, the video conferencing sessions can include a wide range of different types of sessions, such business-related sessions or meetings, social related sessions, and events such as fitness classes, concerts, webinars, stand-up or improv shows, music lessons and various others. Depending on the type of the session, the optimal or improved levels of quality of the audio-visual data streams can vary the audio-visual settings data 312 can define acceptable ranges for adjusting the quality levels of the audio-visual data streams (e.g., increasing relative to a maximum level or decreasing relative to a minimum level). In addition, depending on the type of the session, the quality of video may be more important than the quality of audio, or vice versa in the event of degraded network conditions and communication delays. For example, the quality of the audio component of a musical performance type session can be considered more important than the quality of the video component. In accordance with this example, assuming a network connectivity issue degrades the UP and/or DL rate associated with the data stream being transmitted from and/or received by a participant device, the audio-visual settings assessment component 502 can reduce the quality of the video component of the data stream to maintain a desired level of quality of the audio component of the data stream in real-time.

In addition, depending on the events and occurrences over the course of the session, the quality of video may be more important than the quality of audio of one or more participants data streams, or vice versa. For example, in furtherance to the musical performance example, assume during an intermission period, the music is paused or lowered, and a more visually rich event is feature in the video content (e.g., a visual demonstration or the like). In this context, the system may increase the video quality relative to the audio quality during the intermission period. In another example, the relative priority of one participant's audio and/or video quality to another participant's audio and/or video can vary throughout the session based on events and occurrences throughout the session and the respective priorities associated with the events and occurrences and/or the associated audio-visual content (e.g., increasing the quality of current speaker's audio-video streams relative to non-speakers, increasing the quality of more visually rich data streams associated with one or more participants performing a visual demonstration, activity, etc., relative to one or more participants providing less visually rich video content).

In this regard, in association with determining and adapting the respective audio-visual parameters, the audio-visual settings assessment component 502 can determine and adapt (e.g., update) the respective audio-visual parameters as a function of a context of the video conferencing session and relative priorities of the respective audio-visual parameters with respect to the context. For example, as applied to an audio quality parameter of audio data of the data streams and a video quality parameter of video data of the data streams, in some implementations the audio-visual settings assessment component 502 can enhance the audio quality parameter relative to the video quality parameter of one or more participants data streams based on the context indicating the audio quality parameter has a higher priority relative to the video quality parameter. Likewise, the audio-visual settings assessment component 502 can enhance the video quality parameter relative to the audio quality parameter based on the context indicating the video quality parameter has a higher priority relative to the audio quality parameter.

In association with optimizing audio-video quality based on context, the audio-visual settings assessment component 502 can also tailor the quality of the session audio-visual data streams based on specific contexts and needs of the respective participants. For example, assume a mixed videoconference including individual remote participants and a group of in-person participants located in the same physical conference room using an advanced video conferencing hardware system including a largescale display monitor and multiple high-quality speakers, microphones, and cameras. In this example, the quality of the audio-visual data rendered to the group on the advance video conferencing hardware system may be deemed more important than the quality of the audio-visual data rendered to the individual virtual participants and the audio-visual settings assessment component 502 can control the quality of the respective data streams accordingly.

The LSM component 106 can further monitor (e.g., via monitoring component 414) and analyze (e.g., via audio analysis component 508 and video analysis component 510) the content of the audio-visual data streams of a video conferencing session to detect relevant events that indicate a need to adjust the quality of the audio component and/or video component of the corresponding data stream. For instance, in furtherance to the musical performance example, the monitoring component 414 and the audio analysis component 508 can monitor the audio and/or video content of a data stream during the session to detect pauses or breaks in the musical performance, such as breaks between songs or other event when the music/sound is not in the forefront of the session, such as a lowered period of music in which an image slideshow or another visual demonstration is featured. The audio-visual settings assessment component 502 can further increase the quality of the visual component of the data stream relative to the quality of the audio-component of the data stream during this period of time when the video element is more important. The monitoring component 414 and the audio analysis component 508 can also detect who is speaking and who is not speaking over the course of a session and the audio-visual settings assessment component 502 can change audio-visual settings of the data streams to enhance the quality of the speakers for the time of speaking (e.g., focus network resources on the speaker data stream to give them a higher audio and/or visual quality relative to the other data streams of participants not speaking or talking). In this regard, the LSM component 106 can independently control the quality of the audio and video components of the data streams of a video conferencing session as needed throughout the session based on the relative importance of the respective components with respect to the audio-visual events that occur throughout the session.

In some embodiments, the delay filler component 506 can respond to communication delays by providing additionally or alternative audio-visual content for rendering at one or more participant devices experiencing a delay. For example, the delay detection component 416 can detect visual content frame rendering “freezes” attributed to data communication delays that result in a participant's video stream appearing frozen at another participant's device, such as a frozen and unflattering facial expression. In another example, the delay detection component 416 can detect delays in audio a participant's audio stream that result in the participant's voice coming across as stuttering. The delay filler component 506 can further perform various intelligent responses to account for these issues that minimize and/or counteract their negative impact on the participants session experience. For example, in some embodiments, the delay filler component 506 can employ predetermined audio/visual data for respective participants and employ this predetermined content to fill gaps or delays. For instance, the delay filler component 506 can select predetermined image and/or video content of a participant (and/or an avatar representation of the participant) for rendering instead of a blank screen or frozen, unflattering image of the participant face. For example, in various embodiments, predefined image and/or video content to be used for respective participants in association with filling delay slots can be included with the respective user profiles for the participants (included in user profile data 314). The image/video content can include different image and/or video content to be applied for different session types and/or contexts (e.g., a business/work image and a social image) as defined by the respective participants based on their preferences. In other embodiments, the recording component 418 can record the audio-visual data streams of the respective participant devices over the course of the session and create static image content and/or video clips of the participants from the recorded data (e.g., taken at the beginning of the session and/or time without delays and high-resolution rendering). The recording component 418 can further store the participant image/video content with their profile data for usage by the delay filler component 506.

In various embodiments, the delay filler component 506 can select the appropriate delay filler image/video content for respective participants of a session in association with initiation of a session based on their preferences and the context of the session. In some embodiments in which the LSM component 106 is deployed at one or more edge nodes and/or a version of the delay filler component 506 is deployed at the UE (e.g., as shown in system 200) the delay filler component 506 can pull (e.g., download/preload) participant delay filler content from the user profile data 314 at the initiation of a session. Additionally, or alternatively, the session controller component 410 can further provide the delay filler image/video content to each (or some) of the respective participant devices and direct the participant devices to render the corresponding image content of a participant in response to detection of a rendering delay of the participant's data stream. In this regard, the respective participant devices (and/or their PSM components) can have the delay filler content preloaded and ready for use in the event of a delay. Similarly, in association with initiation of a session, if a participant is not using video capture during a session, the delay filler component can select predefined image/video content of that participant associated with their profile for rendering to other participants (instead of a blank screen) to represent the participant virtually (to enhance the face-to-face experience). The image content selected can be based on the context and type of the session and user preferences. The session controller component 410 can further control rendering of the image content of the participant at all participant devices during the session.

In addition to quality related audio-visual parameters, the audio-visual management component 406 can also control other audio-visual parameters or settings of a video conferencing session in a manner that optimizes the experience for individual participants and/or all participants collectively. In various embodiments, the other audio-visual parameters and settings can include parameters and settings that control the actual content of audio-visual data streams that is rendered to other participants. For example, the audio-visual management component 406 can control the actual content of audio-visual data streams by applying various filters (e.g., included in filter data 316) and/or via other audio-visual editing techniques, and/or by controlling the audio/visual data capture at one or more participant devices (e.g., controlling the respective camera zoom level, orientation, and/or position). In this regard, the audio-visual management component 406 can automatically control and adapt the way respective participants look and sound to others based on their individual preferences and the context of the session by automatically applying various audio-visual filters to the data streams (e.g., by the filter component 514), performing automated audio-visual editing techniques (e.g., by the editing component 512 using the resizing component 516 and the image properties component 518), and/or by controlling the audio/visual data capture (e.g., via audio control component 524 and camera control component 522) at one or more participant devices (e.g., controlling the respective camera zoom level, orientation, and/or position).

For example, in some embodiments in which the participant devices comprise PSM component 112_{1-N} with local versions of the audio-visual management component 406, the PSM components can filter and edit data streams prior to sending and/or filter and edit received data streams prior to rendering. With these embodiments, the camera control component 522 and the audio control component 524 can also access and control the corresponding audio-visual hardware of the respective participant devices. In other implementations. in which one or more participant devices do not include PSM, audio-visual management component 406 can intercept and edit and filter the data streams communicated between the devices. With these implementations, the camera control component 522 and the audio control component 524 can also remotely access and control the corresponding audio-visual hardware of the respective participant devices. In this manner, the audio-visual management component 406 can correspond to a live (e.g., in real-time or substantially real-time), intelligent audio-visual director, producer and editor of the image and audio content of a video conference, tailoring the image and video content presented to respective participants individual and collectively in a manner that optimizes the experience for all participants. In additions, users do not need to worry about having the technical expertise of the videoconferencing software to control the audio-visual settings themselves.

In this regard, with respect to individual participants, in one or more embodiments, the editing component 512 can automatically change a participant's voice and image properties as needed based on context of the session and their individual preferences. User preferences regarding how they prefer to look and sound in respective contexts and meeting/conference types can be predefined in their user profile data and/or learned by artificial intelligence component 422 over time based on their logged session data. In some embodiments, the editing component 512 can apply user preference defined filters and/or other audiovisual editing preferences tailored to a particular editing session and context at the initiation of session. The editing component 512 can also edit the audio-visual content as needed over the course of the session in real-time.

For example, the filter component 514 can automatically apply visual and audio filters that make you look and sound a specific way that is appropriate or preferred for the context of the session. (e.g., work verses social). For instance, the image filters can include filters that change the appearance of one's face, body, and/or clothing tailored to a particular context (e.g., work attire vs. social attire). Similarly, the audio filters can include filters that change the sound of one's voice (e.g., tone, pitch, timbre, etc.) in a manner optimized for the conference/meeting. For example, the audio filters can include filters that change your voice to make you sound more or less authoritative, professional, cheery/chipper, awake, serious, etc., and filters that minimize the sound of a scratchy, hoarse throat. In some implementations, the audio filters can include filters that correct one or more speech impediments (e.g., stuttering, articulation errors, ankyloglossia, apraxia, dysarthria, etc.). The audio filters can also include filters that reduce or remove vocal disfluencies, commonly described as filler words, such as um, ah and like, which may be selectively applied or not for certain contexts (e.g., work verses social). The audio filters can also include various other social filters that change one's voice in a fun or entertaining manner, such as filters that make you sound younger or older, filters that make you sound like a cartoon character, and the like. In some implementations, the audio filters can include filters that change a person's accent by increasing or decreasing the properties of the accent. For example, the filter component 514 can apply an accent minimizing filter to minimize a particular participants accent to make them easier to understand to other participants. In accordance with this example, the filter component 514 may automatically select and apply such an accent modification filter to a participants audio feed based on a determination that one or more other participants in the meeting may have difficulty understanding the participant's accent (e.g., based on differences in location, ethnicity, and/or as indicated in their user preferences).

The filter component 514 can also selectively apply audio-visual filters to a participants data steam as rendered to one or more select other participants. In this regard, the filter component 514 can tailor the way a participant looks and sounds to respective other participants independently and separately. For example, the filter component 514 can control application of an accent reduction filter for a first participant's audio stream as rendered to a second participant's device while streaming the first participants audio stream to a third participants device unfiltered. The filter component 514 can also control the particular filters audio-visual filters are applied to account for the identities of the other participants (e.g., who else is on the call to which you will be communicating), the time of day, the day of year, a theme associated with the session and various other contextual factors. The audio-visual management component 406 can also provide respective participants with a corresponding rendering of how they look and sound to the other participants with the adjusted sound and/or image properties.

The interface adaptation component 528 can also automatically determine and apply select background image content tailored to respective types and contexts of a videoconferencing session. For example, the interface adaptation component 528 can determine or infer a particular conference is for a company meeting and control rendering of a company logo background for the meeting at respective virtual participant devices automatically at the initiation of the session. and apply background image content. Similarly, the interface adaptation component 528 can automatically apply one or more predefined background image content settings based on user defined preferences indicating preferred settings for one or more sessions (e.g., based on session context and/or explicitly requested in the meeting scheduling).

The resizing component 516 and the image properties component 518 can also perform audio-visual editing to data streams to change the audio-visual properties of the data streams. For example, the resizing component 516 and the image properties component 518 can automatically determine and control visual image data editing changes, such as cropping, centering, enlarging, changing coloration, hue, brightness, contrast, lighting, and so on (e.g., even if the original data stream image content is not captured that way).

In some embodiments, the positioning component 520 and the camera control component 522 can also automatically determine and control optimal or improved camera settings of participant devices that control the position, orientation, field-of-view (FOV), and/or zoom level of participant device cameras. For example, in some implementations, the positioning component 520 component can facilitate directing a participant how to position themselves relative to the camera in an optimal or at least better manner for the context of the session, such positioning their face and/or body at a particular position/orientation relative to the camera (e.g., moving forward or backward, left or right, where to look, etc.). For instance, depending on the type and context of the session, the optimal or improved image data for the session may include a close-up a person's face only, a perspective of the persons upper body, a perspective of the persons full body, and/or a perspective of the person's surrounding environment. Additionally, or alternatively, the camera control component 522 can automatically determine and control the camera settings of participant devices in manner determined to capture the optimal or improved image data of the participants and/or their environment based on the context of the session and their preferences. For example, the camera control component 522 can control the position, orientation, field-of-view (FOV), and/or zoom level of a participant's device camera to obtain a particular desired perspective of the participant and/or their environment (e.g., facial close-up, upper body, full body, environment, etc.).

The audio-visual management component 406 can further intelligently adapt and change audio-visual filters, editing operations and camera settings as needed throughout the session automatically based on contextual events that occur during the session as determined based on analysis of the audio-visual content of the data streams. For example, the audio analysis component 508 can detect if you are speaking too loudly, too softly, too slowly, too quickly, etc., and autocorrect this by notifying you at your participant device (e.g., via notification component 526) and and/or automatically applying filters (e.g., via the filter component 514) to the data streams or controlling the data stream communication rate (e.g., via session controller component 410 and resource allocation component 408) so that rendering is impacted accordingly. For instance, if you start speeding up your speech too fast, the LSM component 106 can respond by controlling the rendering of your voice to other participants devices at slower rate. The audio-visual management component 406 can also automatically detect and filter unwanted background noises as it arises, wherein what constitutes unwanted background noise can be tailored to different session types, contexts and/or user preferences. The audio control component 524 can also automatically control volume settings as needed based on detected changes sound volume and other contextual events. The audio control component 524 can also automatically control muting and unmuting voices of participants as needed. In some embodiments, the audio analysis component 508 and the video analysis component 510 can detect when you are speaking but muted (e.g., based on mouth moving yet mut is on) and notify (e.g., via notification component 526) you and/or automatically change your audio setting to unmuted (via audio control component 524). Similarly, the audio analysis component 508 and the video analysis component 510 can detect when you are speaking in a manner in which you assume you're muted but not (e.g., based on sound content being out of accord with the norms of the session and/or the background noise associated therewith) and notify (e.g., via notification component 526) you and/or automatically change your audio setting to muted (via audio control component 524). The audio analysis component 508 can also interpret other audio streams in association with detecting audio and sound issues, such as using natural language processing (NLP) to interpret feedback from other participants indicating ‘they cannot hear or see a participant,’ or ‘they cannot hear or see them clearly,’ or ‘hey participant you're not muted’ or etc., to facilitate detecting issues related to audio-visual settings and/or another causes (e.g., an equipment issues, a network connection issue, etc.). In some embodiments, the video analysis component 510 can also process image data included in the data streams to detect when you are slouching, looking away from camera, positioned incorrectly or otherwise sub-optimally relative to the camera, or performing any defined action that warrants attention and directions/correction and notify you (e.g., via notification component 526).

The camera control component 522 can also dynamically adapt camera settings to capture desired perspectives and/or image content over the course of a video conference based on events and occurrences detected throughout the conference, as determined based on analysis of the image content (e.g., via video analysis component 510 and audio content (e.g., via audio analysis component 508) or via other mechanisms. For example, the video analysis component 510 can detect when participants move and need repositioning relative to the camera and the positioning component 520 can direct the participants accordingly and/or the camera control component 522 can automatically correct for their movement by changing the position, orientation, FOV and/or zoom level of the camera. The video analysis component 510 can also interpret image and audio cues based on analysis of the audio-visual content to determine optimal or improved camera views and the camera control component 522 can adapt the camera settings accordingly. For example, the camera control component 522 can adapt camera settings and/or position to follow a person as the move about a room to maintain a desired perspective of the person based on detection of their movement in the image data feed. In another example, the camera control component 522 can adapt cameras settings and position to maintain the appearance of eye contact of the participant when the move their gaze away from the camera (to maintain eye contact). In another example, the audio analysis component 508 can detect verbal cues, such as person indicates they are describing an object they are holding or describing in their environment and the camera control component 522 and/or the position component 520 can control directing the camera to provide a perspective of the object at that time. In another example, as applied to mixed video conferencing comprising one or more remote virtual participants and a group of participants located in the same physical room/environment, the camera control component 522 can control adapting the camera position, orientation, FOV and/or zoom level to focus on different participants over the course of the session as needed based on the context of the session. For example, the audio analysis component 508 can detect who is currently speaking and the camera control component 522 can change the camera perspective to focus on the current speaker (e.g., based on direction given from the positing component 520 and/or using facial recognition detection). In other implementations, the camera control component 522 can direct the camera to operate in different dynamic modes, such as panning and scanning the room in a random or calculated fashion to provide different perspectives of the group environment and the group participants over the course of the meeting.

In some implementation of these group scenarios, the audio-visual management component 406 can also generate multiple different image feeds of the group environment for rending to the one or more virtual participants (e.g., in different windows or tiles on the one or more virtual participants display monitors). For example, in scenarios in which the group environment comprises multiple (e.g., two or more) cameras, the audio-visual management component 406 can generate different views of the group environment from the different cameras, such as a perspective of the entire group and a close-up perspective of the current speaker and adapt the views as needed based on changes in the user activity/context of the session. In other implementations in which the group environment employs a single camera, the editing component 512 can edit the image data feed captured from the single camera to generate the different views. For example, the camera control component 522 can direct the single camera to capture a perspective of the entire group (e.g., all participants) and/or direct the group to initially set up the camera perspective to capture the entire group. The editing component 512 can further generate one or more duplicate copies of the camera feed and edit the respective copies in real-time via cropping and/or zooming to create additional image data feeds that provide different perspectives of the group (e.g., a second feed providing close-up of the current speaker, a third feed providing a perspective of a particular person in the group that the current speaker is addressing, and so on).

Still in other embodiments, the audio-visual management component 406 can employ previously captured image data of group participants in association with generating and rendering different image view feeds of the group for rending to one or more remote participants. For example, in some implementations, depending on the camera set-up in the group environment (e.g., number and position of the cameras) it may not be possible to capture a live view of all participants and/or all the participants at the same time. With these embodiments, the audio-visual management component 406 can employ pre-recoded static image data of respective participants (e.g., actual images of the participants and/or avatar representations) in the group and/or video clips of the respective participants (e.g., associated with their profiles and/or generated by the recording component 418). For example, the audio-visual management component 406 can control presenting the one or more virtual participants with a view of the live-camera feed and one or more additional views of the participants in the group comprising previously captured image data of the participants. The particular view that are presented can also be tailored based on the context and events that occur in the session. For example, assume a live seminar video conferencing session scenario in which a speaker is addressing the question of an audience member and the camera capabilities in the environment cannot capture a live perspective of the audience member. In this scenario, the audio-visual management component 406 can access and render previously captured image data of the audience member for rendering to a virtual participant watching the live seminar at the time the speaker is addressing the question of the audience member.

In some embodiments, the mediator component 420 can also provide a moderator or mediator functionality to control sequencing of respective virtual participants speaking over the course of a video conferencing session. For example, the mediator component 420 can detect when multiple people speak up at the same time (e.g., using audio analysis component 508) and provide a moderator mechanism to control talking order and/or priority. In some implementations, the mediator component 420 can control talking order as a function of first to speak. For example, the mediator component 420 can detect the precise order in which the respective participants spoke around the same time and assign a priority order for speaking accordingly. The mediator component 420 can also determine talking order as a function of user preferences, defined user roles in the meeting and associated predetermined speaking priority hierarchy of the respective participants and/or roles and/or participants, and other factors. In some embodiments, the mediator component 420 can direct the respective participants regarding the detected order and the participants can follow the direction accordingly at their discretion. For example, the mediator component 420 can facilitate rendering speaking order signals on the respective participants displays indicating their detected order for speaking (e.g., numbers 1, 2, and 3 indicating order to speak of three participants). The mediator component 420 can also automatically control the volume (e.g., increasing or decreasing) and/or mute settings of the respective participants according to the talking order (e.g., using audio control component 524).

In some embodiments, the interface adaptation component 528 can also automatically determine, control and adapt the display configuration of respective participants graphical user interfaces (GUIs) based on user preference, meeting context and contextual events that occur over the course of a session. For example, in some embodiments, the GUI of respective participants in a video conferencing session can comprise separate window or thumbnail views of the other participants, including live video feeds, static image content and/or pre-recorded video content. The separate windows may also comprise different perspective or view of a group environment as described above. The interface adaptation component 528 can further adapt the position, arrangement, size and display of the respective window views automatically over the course of the session as a function of context of the session to tailor the GUI based on relevancy and/or dynamically (e.g., dynamically changing the view in a scrolling random fashion). For example, depending on the amount of display screen real-estate, the number of participants and/or the number of available views, it may not be feasible to include windows with every view on the screen at the same time. Accordingly, the interface adaptation component 528 can selectively choose what view to display and when based on the context of the session, predefined priority hierarchies associated with different participants, and user preferences. For example, the interface adaptation component 528 can arrange the views to include a view of whoever is currently speaking in a primary position on the display screen. In another example, assume a video conferencing session that involves participants performing physical activities/actions (e.g., demonstrating a physical task or movement, dancing, exercising, etc.). The interface adaptation component 528 can arrange the views in a priority order based on who is performing the most activity/action at the current time (e.g., as determined based on analysis of the image content of the video feeds and/or using motion sensor feedback). The interface adaptation component 528 can also adjust the size of the respective window views as function of relevancy and priority throughout the duration of the session. For example, the interface adaptation component 528 can control increasing the size of a view of the current speaker relative to rendered views of other participants.

In various embodiments, the artificial intelligence component 422 can further employ machine (ML) learning and artificial intelligence (AI) techniques to learn optimal or improved audio-visual parameters and settings for different types of conferencing sessions under different contexts and network conditions. The LSM component 106 can further generate predefined audio-visual parameter setting templates (e.g., included in the audio-visual settings data 312) for the different types of conferencing sessions, contexts, user preferences and network conditions and employ the template configurations in association with determining, applying and adjusting the audio-visual parameters and settings for similar video conferencing sessions. The artificial intelligence component 422 can also employ ML and AI techniques to learn user preferences regarding preferred audio-visual parameters and settings and apply these preferences in future video conferencing sessions in which the users participate.

Referring back to FIG. 2, many operations of the video conferencing system 104 described herein can involve utilization of artificial intelligence and machine learning facilitated by the artificial intelligence component 422. To facilitate this end, the artificial intelligence component 422 can perform learning with respect to any and all of the data received by the video conferencing system 104, stored by the video conferencing system 104 scheduling data 310, audio-visual settings data 312, user profile data 314, filter data 316, and logged session data 318), generated by the video conferencing system 104 (e.g., audio-visual parameters and settings for different sessions and contexts) and accessible to the surveillance system 120 (e.g., network resource data 311 and device scheduling data 313). Hereinafter, any information received by, generated by, stored by, and/or accessible to the video conferencing system 104 is collectively referred to as “collective machine learning data.”

It should be appreciated that artificial intelligence component 422 can perform learning associated with the collective machine learning data explicitly or implicitly. Learning and/or determining inferences by the artificial intelligence component 422 can facilitate identification and/or classification of different patterns associated with the collective machine learning data, determining one or more rules associated with collective machine learning data, and/or determining one or more relationships associated with the collective machine learning data that influence determinations and inferences by the LSM component 106 and/or the PSM components 204_{1-N}. The artificial intelligence component 422 can also employ an automatic classification system and/or an automatic classification process to facilitate identification and/or classification of different patterns associated with the collective machine learning data, determining one or more rules associated with collective machine learning data, and/or determining one or more relationships associated with the collective machine learning data that influence determinations and inferences by LSM component 106 and/or the PSM components 204_{1-N}. For example, the artificial intelligence component 422 can employ a probabilistic and/or statistical-based analysis (e.g., factoring into the analysis utilities and costs) to learn one or more patterns associated with the collective machine learning data, determining one or more rules associated with collective machine learning data, and/or determining one or more relationships associated with the collective machine learning data that influence determinations and inferences by the LSM component 106 and/or the PSM components 204_{1-N}. The artificial intelligence component 422 can employ, for example, a support vector machine (SVM) classifier to facilitate learning patterns associated with the collective machine learning data, determining one or more rules associated with collective machine learning data, and/or determining one or more relationships associated with the collective machine learning data that influence determinations and inferences by the LSM component 106 and/or the PSM components 204_{1-N}. Additionally, or alternatively, the artificial intelligence component 422 an employ other classification techniques associated with Bayesian networks, decision trees and/or probabilistic classification models. Classifiers employed by the artificial intelligence component 422 can be explicitly trained (e.g., via a generic training data) as well as implicitly trained (e.g., via observing user behavior, receiving extrinsic information). For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

In an aspect, the artificial intelligence component 422 can utilize in part inference-based schemes to facilitate learning one or more patterns associated with the collective machine learning data, determining one or more rules associated with collective machine learning data, and/or determining one or more relationships associated with the collective machine learning data that influence determinations and inferences by the LSM component 106 and/or the PSM components 204_{1-N}. The artificial intelligence component 422 can further employ any suitable machine-learning based techniques, statistical-based techniques and/or probabilistic-based techniques. The artificial intelligence component 422 can additionally or alternatively employ a reduced set of factors (e.g., an optimized set of factors) to facilitate generating one or more machine learning models configured to perform automated inferencing tasks related to the LSM component 106 and/or the PSM components 204_{1-N}. For example, the artificial intelligence component 422 can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, etc. In another aspect, the artificial intelligence component 422 can perform a set of machine learning computations associated with collective machine learning data. For example, the artificial intelligence component 422 can perform a set of clustering machine learning computations, a set of decision tree machine learning computations, a set of instance-based machine learning computations, a set of regression machine learning computations, a set of regularization machine learning computations, a set of rule learning machine learning computations, a set of Bayesian machine learning computations, a set of deep Boltzmann machine computations, a set of deep belief network computations, a set of convolution neural network computations, a set of stacked auto-encoder computations and/or a set of different machine learning computations. Any rules, patterns, and/or correlations learned by the artificial intelligence component 422 with respect to the collective machine learning data can further be stored in the by the computing system (e.g., in storage 308, memory 320, one or more edge datacenters associated with the edge network 206 and/or respective memory structures employed by the respective UEs 112_{1-N}), applied by the artificial intelligence component 422 to define, and/or update/refine the audio-visual settings data 312, the user profile data 314 and/or to generate one or more machine learning models configured to perform automated inferencing tasks related to the LSM component 106 and/or the PSM components 204_{1-N}.

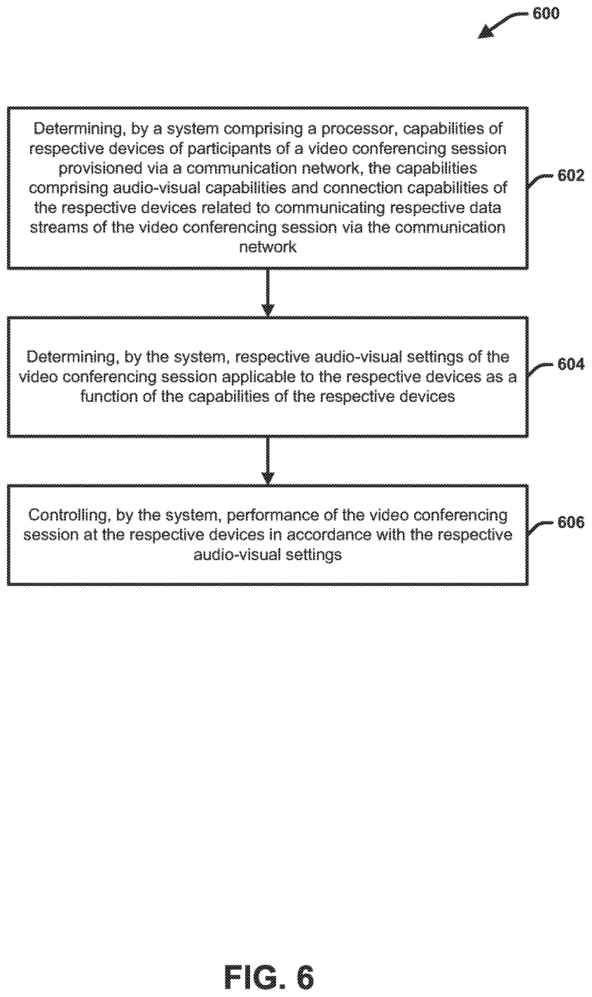

FIG. 6 illustrates a high-level flow diagram of an example computer-implemented process 600 that facilitates detecting and minimizing social and virtual threats using a communication network in accordance with one or more embodiments of the disclosed subject matter. At 602, process 600 comprises identifying, by a system comprising a processor (

FIG. 6 illustrates a high-level flow diagram of an example computer-implemented process 600 that facilitates intelligent management of adaptable audio-visuals of cloud-based video conferencing sessions in accordance with one or more embodiments of the disclosed subject matter. At 602, process 600 comprises determining, by a system comprising a processor (e.g., via system 100, system 200 or the like), capabilities of respective devices of participants of a video conferencing session provisioned via a communication network (e.g., communication network 110), the capabilities comprising audio-visual capabilities and connection capabilities of the respective devices related to communicating respective data streams of the video conferencing session via the communication network (e.g., determined via the capabilities assessment component 404). At 604, method 600 comprises determining, by the system, respective audio-visual settings of the video conferencing session applicable to the respective devices as a function of the capabilities of the respective devices (e.g., via the audio-visual settings assessment component 502). At 606, method 600 further comprises controlling, by the system, performance of the video conferencing session at the respective devices in accordance with the respective audio-visual settings (e.g., via session controller component 410, resource allocation component 408, resource management system 108, respective PSM component 204_{1-N} of the participant devices, and/or various other components of the LSM component 106).

For example, in some implementations, the respective audio-visual settings can comprise respective preferred measures of audio quality and video quality to be rendered by the respective devices. With these implementations the audio-visual settings can include any settings related to audio-visual data capture and rendering to be applied and controlled by the respective participant devices. Additionally, the audio-visual settings can include any settings to be applied by the communication network 110 that control the communication of the data streams between the respective devices that influence audio-visual streaming rending quality, (e.g., resource allocations that influence UP and DL latency, reliability, bandwidth, throughput, etc. and communication link quality). The audio-visual settings can also include settings regarding audio-visual quality conversion to be performed on the audio-visual data streams by the quality conversion component 504.

Additionally, or alternatively, the respective audio-visual settings can comprise any settings related to the data content of the audio-visual data captured and/or rendered by the respective participant devices that control or influence the content, sound and appearance of the data. For example, the settings can include filter settings, audio-visual property settings to be applied by the resizing component 516 and the image properties component 518, participant device camera capture settings regarding position, orientation, field of view, audio volume settings and so on. The audio-visual settings can also include settings that control the background content, user delay filler content and/or image content for rendering instead of a participants camera feed (e.g., representative static image content and/or video content of the participant) and the display arrangement and configuration of respective participants GUIs.

In some embodiments, in association with initialization of the session, the audio-visual management component 406 can determine or infer (e.g., using artificial intelligence component 422) some or all of these audio-visual settings applicable to some or all of the participant devices and control application of the respective settings by some or all of the settings by the respective devices (e.g., by the audio-visual settings assessment component 502 and/or one other components of the audio-visual management component 406). Thereafter the LSM component 106 and/or corresponding PSM components 204_{1-N} can monitor and automatically adapt the one or more of the audio-visual settings as needed over the course of the session in real-time to account for changes in network conditions and events and occurrences throughout the session. In various embodiments, the respective settings applied to the participant device can be determined as function of balancing their respective device capabilities and preferences to provide a balance and harmonized experience for all participants with respect to audio-visual quality. In some implementations, to facilitate this end the audio-visual management component 406 can employ same or similar setting configurations determined to be appropriate for the type of the conferencing session based on the respective participant device capabilities, the context of the session and the preferences of the respective session participants (e.g., as defined in one or more templates in the audio-visual settings data 312, user profile data 314, determined based on ML and AI analysis of logged session data 318, and so on).

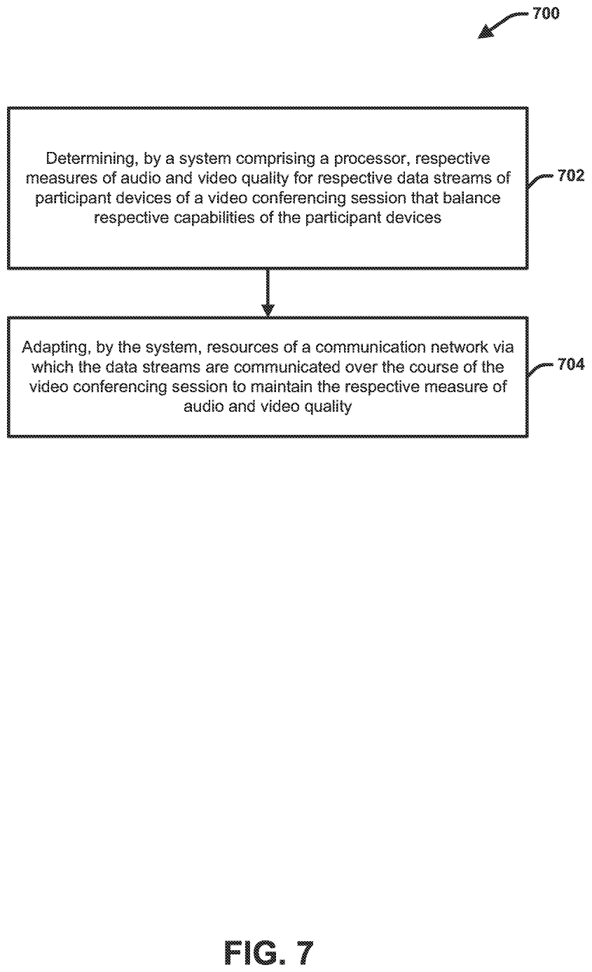

FIG. 7 illustrates a high-level flow diagram of an example computer-implemented process 700 that facilitates intelligent management of adaptable audio-visuals of cloud-based video conferencing sessions in accordance with one or more embodiments of the disclosed subject matter. At 702, process 700 comprises determining, by a system comprising a processor (e.g., via system 100, system 200 or the like), respective measures of audio and video quality for respective data streams (e.g., and more particular for rendering the respective data streams) of participant devices of a video conferencing session that balance respective capabilities of the participant devices (e.g., via the audio-visual settings assessment component 502). At 704, method 700 further comprises adapting, by the system, resources of a communication network via which the data streams are communicated over the course of the video conferencing session to maintain the respective measure of audio and video quality (e.g., via the resource allocation component 408, the session controller component 410 and/or the resource management system 108). Additionally, or alternatively, the system can adapt the quality of one or more of the data streams using the quality conversion component 504 and/or via other techniques described herein as needed to account for network delays (e.g., increasing or decreasing the quality of the audio and/or video components of the data streams to minimize forecasted network delays and other issues) and/or to account for other contextual events (e.g., increasing the audio quality of current speakers at time of speaking while decreasing the quality of one or more audio-visual components of non-speaker data streams, slowing rendering speed of one's audio when speaking to fast, etc.).

In this regard, determining the respective audio-visual parameters can comprises determining the respective audio-visual parameters as a function of a context of the video conferencing session and relative priorities of the respective audio-visual parameters with respect to the context. As applied to an audio quality parameter of audio data of the data streams and a video quality parameter of video data of the data streams, the determining the respective audio-visual parameters in some implementations can comprise enhancing the audio quality parameter relative to the video quality parameter based on the context indicating the audio quality parameter has a higher priority relative to the video quality parameter. Likewise, in other implementations, the determining the respective audio-visual parameters in some implementations can comprise enhancing the video quality parameter relative to the audio quality parameter based on the context indicating the video quality parameter has a higher priority relative to the audio quality parameter.

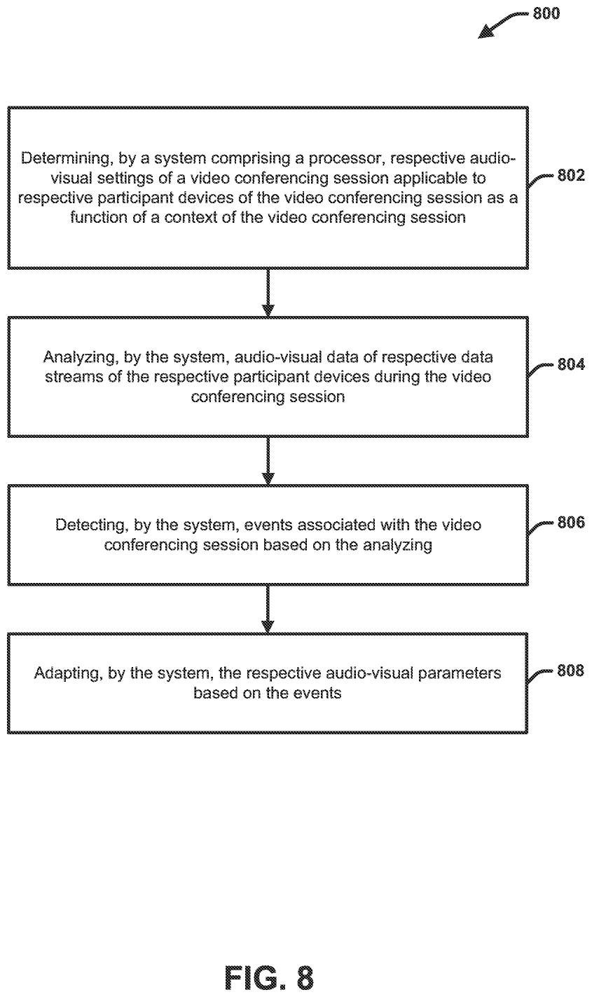

FIG. 8 illustrates a high-level flow diagram of an example computer-implemented process 800 that facilitates intelligent management of adaptable audio-visuals of cloud-based video conferencing sessions in accordance with one or more embodiments of the disclosed subject matter. At 802, process 800 comprises determining, by a system comprising a processor (e.g., via system 100, system 200 or the like), respective audio-visual settings of a video conferencing session applicable to respective participant devices of the video conferencing session as a function of a context of the video conferencing session (e.g., by audio-visual management component 406). At 802, method 800 comprises analyzing, by the system, audio-visual data of respective data streams of the respective participant devices during the video conferencing session (e.g., via audio analysis component 508, video analysis component 510, monitoring component 414, delay detection component 416, mediator component 420, and other components). At 806, method 800 further comprises detecting, by the system, events associated with the video conferencing session based on the analyzing (e.g., via audio analysis component 508, video analysis component 510, monitoring component 414, delay detection component 416, mediator component 420, and other components). For example, the detecting the events can include detecting delays, detecting multiple speaking up simultaneously, detecting speaking when muted, detecting current speakers, detecting audio-visual content to enhance or decrease quality thereof, detecting stuttering or speaking too fast/slow, detecting eye movement and changing focus of the camera, detecting and following movement of participants in a room, and various other examples. At 808, method 800 further comprises adapting, by the system, the respective audio-visual parameters based on the events (e.g., via various different components of the LSM component 106 depending on the event and the type of adapting needed or preferred to optimize the experience for individual participants or all participants collectively).

One or more embodiments can be a system, a method, and/or a computer program product at any possible technical detail level of integration. The computer program product can include a computer readable storage medium (or media) having computer readable program instructions thereon for causing a processor to carry out one or more aspects of the present embodiments.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, procedural programming languages, such as the “C” programming language or similar programming languages, and machine-learning programming languages such as like CUDA, Python, Tensorflow, PyTorch, and the like. The computer readable program instructions can execute entirely on the user's computer, partly on the user's computer, as a stand-alone software package, partly on the user's computer and partly on a remote computer or entirely on the remote computer or server using suitable processing hardware. In the latter scenario, the remote computer can be connected to the user's computer through any type of network, including a local area network (LAN) or a wide area network (WAN), or the connection can be made to an external computer (for example, through the Internet using an Internet Service Provider). In various embodiments involving machine-learning programming instructions, the processing hardware can include one or more graphics processing units (GPUs), central processing units (CPUs), and the like. In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and a drive 920, e.g., such as a solid state drive, an optical disk drive, which can read or write from a disk 922, such as a CD-ROM disc, a DVD, a BD, etc. Alternatively, where a solid state drive is involved, disk 922 would not be included, unless separate. While the internal HDD 914 is illustrated as located within the computer 902, the internal HDD 914 can also be configured for external use in a suitable chassis (not shown). Additionally, while not shown in environment 900, a solid state drive (SSD) could be used in addition to, or in place of, an HDD 914. The HDD 914, external storage device(s) 916 and drive 920 can be connected to the system bus 908 by an HDD interface 924, an external storage interface 926 and a drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enable with a security module, such as a trusted processing module (TPM). For instance with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can be also connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are example and other means of establishing a communications link between the computers can be used.

When used in either a LAN or WAN networking environment, the computer 902 can access cloud storage systems or other network-based storage systems in addition to, or in place of, external storage devices 916 as described above, such as but not limited to a network virtual machine providing one or more aspects of storage or processing of information. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The illustrated aspects of the disclosure may also be practiced in distributed computing environments where certain tasks are performed by remote processing devices that are linked through a communications network. In a distributed computing environment, program modules can be located in both local and remote memory storage devices.

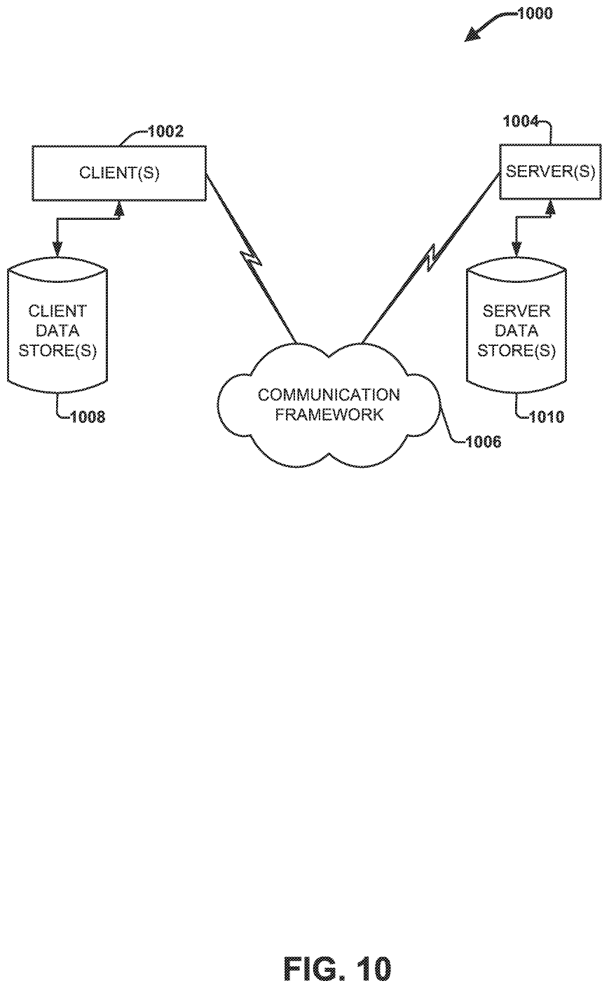

Referring to FIG. 10, there is illustrated a schematic block diagram of a computing environment 1000 in accordance with this disclosure in which the subject systems (e.g., system 100, system 200 and the like), methods and computer readable media can be deployed. The computing environment 1000 includes one or more client(s) 1002 (e.g., laptops, smart phones, PDAs, media players, computers, portable electronic devices, wearable devices, tablets, and the like). The client(s) 1002 can be hardware and/or software (e.g., threads, processes, computing devices). The computing environment 1000 also includes one or more server(s) 1004. The server(s) 1004 can also be hardware or hardware in combination with software (e.g., threads, processes, computing devices). The servers 1004 can house threads to perform transformations by employing aspects of this disclosure, for example. In various embodiments, one or more components of system 100 and system 200 can be deployed as hardware and/or software at a client 1002 and/or as hardware and/or software deployed at a server 1004. One possible communication between a client 1002 and a server 1004 can be in the form of a data packet transmitted between two or more computer processes wherein the data packet may include audio-visual data streams, device capabilities information, audio-visual settings instructions, and the like. The data packet can include a metadata, e.g., associated contextual information, for example. The computing environment 1000 includes a communication framework 1006 (e.g., a global communication network such as the Internet, or mobile network(s)) that can be employed to facilitate communications between the client(s) 1002 and the server(s) 1004.

Communications can be facilitated via a wired (including optical fiber) and/or wireless technology. The client(s) 1002 include or are operatively connected to one or more client data store(s) 1008 that can be employed to store information local to the client(s) 1002. Similarly, the server(s) 1004 are operatively include or are operatively connected to one or more server data store(s) 1010 that can be employed to store information local to the servers 1004.

In one embodiment, a client 1002 can transfer an encoded file, in accordance with the disclosed subject matter, to server 1004. Server 1004 can store the file, decode the file, or transmit the file to another client 1002. It is to be appreciated, that a client 1202 can also transfer uncompressed file to a server 1004 can compress the file in accordance with the disclosed subject matter. Likewise, server 1004 can encode video information and transmit the information via communication framework 1006 to one or more clients 1002.

FIG. 11 illustrates an example schematic system block diagram of an edge network 1100 according to one or more embodiments. The edge network 1100 can comprise a cloud-based architecture 1102 by use of a cloud server 1104 and a content database 1106. The cloud-based architecture 1102 can be in communication with one or more edge nodes (e.g., edge node 1108, edge node 1116, etc.). It should be noted that although FIG. 11 depicts two edge nodes, any number of edge nodes are possible to facilitate the spirit of this disclosure. The edge nodes can move services to the edge, where they can provide content caching, service delivery, storage, and/or IoT management resulting in better response times and transfer rates ideal for various use cases. Each edge nodes 1108, 1116 can comprise their own servers and content databases to store relevant content. Access points 1110, 1118 can be utilized to facilitate communication with UEs (e.g., UE 1102, which can correspond to one or more of the UEs 112_{1-N}). For example, edge node 1108 can communicate with the UE 1102 via the access point 1110, such that wireless services are readily available for the UE 1102. These wireless services can also be hosted at and/or communicated over the cloud-based architecture 1102 to the server 1104 and content database 1106. The edge nodes 1108, 1116 can be distributed in such a manner that when the UE 1102 is out of range (or nearing a range threshold) of the access point 1110, the access point 1118 can begin communicating with the UE 1102 such that there is no disruption in any of the services that were being provided to the UE 1102 by the access point 1110. In various embodiments, one or more systems disclosed herein (e.g., system 100, system 200) can employ an edge network 1100 to facilitate provisioning adaptable audio-visual elements of a video conferencing session. For example, with reference to FIGS. 2-3 in view of FIG. 11, in some embodiments, the LSM component 106 or one or more components of the LSM component can be deployed at one or more edge nodes 1108, 1116 in corresponding edge servers. In some implementations of these embodiments, the storage 308 can be included in content database 1106 and managed by the video conferencing system 104 deployed at server 1104. With these embodiments, in association with initiation of a video conferencing session, the LSM component 106 can access and retrieve relevant content (e.g., user profile data, audio-visual settings template data, filters, pre-loaded image/audio content for filling delays, etc.) that may be needed for the video-conferencing session from the content database 1106 and store the content in one or more edge content databases as the corresponding edge nodes.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “subsystem” “platform,” “layer,” “gateway,” “interface,” “service,” “application,” “device,” and the like, can refer to and/or can include one or more computer-related entities or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of entity equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor; and
a memory that stores executable instructions that, when executed by the processor, facilitate performance of operations, comprising:
determining capabilities of respective devices of participants of a video conferencing session provisioned via a communication network, the capabilities comprising audio-visual capabilities and connection capabilities of the respective devices related to communicating respective data streams of the video conferencing session via the communication network;
determining respective audio-visual parameters of the video conferencing session applicable to the respective devices as a function of the capabilities of the respective devices; and
controlling performance of the video conferencing session at the respective devices in accordance with the respective audio-visual parameters.

2. The system of claim 1, wherein the respective audio-visual parameters represent respective measures of audio and video quality and wherein the determining respective audio-visual parameters comprises determining the respective audio-visual parameters to balance the respective measures of audio and video quality at the respective devices.

3. The system of claim 2, wherein the operations further comprise:
monitoring the respective measures of audio and video quality at the respective devices during the video conferencing session; and
adapting the respective audio-visual parameters based on changes to the respective measures of audio and video quality.

4. The system of claim 2, wherein the controlling comprises controlling respective communication parameters applicable to communicating the respective data streams in accordance with the respective audio-visual parameters.

5. The system of claim 4, wherein the respective communication parameters are selected from a group of communication parameters comprising: a downlink speed parameter, an uplink speed parameter, a latency parameter, and a reliability parameter.

6. The system of claim 4, wherein the operations further comprise:
monitoring the respective measures of audio and video quality at the respective devices during the video conferencing session; and
adapting the respective communication parameters based on changes to the respective measures of audio and video quality determined based on the monitoring.

7. The system of claim 6, wherein the adapting comprises re-allocating network resources of the communication network used to communicate the respective data streams in accordance with the respective communication parameters.

8. The system of claim 1, wherein determining the respective audio-visual parameters comprises determining the respective audio-visual parameters as a function of a context of the video conferencing session and relative priorities of the respective audio-visual parameters with respect to the context.

9. The system of claim 8, wherein the respective audio-visual parameters comprise an audio quality parameter of audio data of the data streams and a video quality parameter of video data of the data streams, and wherein the determining the respective audio-visual parameters comprises enhancing the audio quality parameter relative to the video quality parameter based on the context indicating the audio quality parameter has a higher priority relative to the video quality parameter.

10. The system of claim 1, wherein determining the respective audio-visual parameters comprises determining the respective audio-visual parameters as a function of a context of the video conferencing session and respective preferences of the participants.

11. The system of claim 1, wherein determining the respective audio-visual parameters comprises selecting background image content for rendering at the devices based on the context of the video conferencing session, and wherein the controlling further comprises:
controlling the rendering of the background image content at the devices during the video conferencing session.

12. The system of claim 1, wherein determining the respective audio-visual parameters comprises determining an audio filter or a video filter to apply to a data stream of the respective data streams based on a context of the video conferencing session and a preference associated with a participant identity of a participant in the video conferencing session and associated with the data stream, and wherein the controlling comprises applying the audio filter of the video filter to the data stream.

13. The system of claim 1, wherein the operations further comprise:
detecting a rendering delay of a data stream of the respective data streams at a device of the devices;
selecting image data or audio data associated a participant identity of a participant in the video conferencing session and associated with the data stream; and
controlling rendering of the image data or the audio data at the device in association with the rendering delay.

14. The system of claim 1, wherein the operations further comprise:
analyzing audio-visual data of the respective data streams during the video conferencing session;
detecting events associated with the video conferencing session based on the analyzing; and
adapting the respective audio-visual parameters based on the events.

15. The system of claim 1, wherein the operations further comprise:
monitoring eye movement of the participants of the video conferencing session; and
controlling capture of image data of the respective data streams as a function of the eye movement.

16. A method, comprising:
determining, by a system comprising a processor, capabilities of respective devices of participants of a video conferencing session provisioned via a communication network, the capabilities comprising audio-visual capabilities and connection capabilities of the respective devices related to communicating respective data streams of the video conferencing session via the communication network;
determining, by the system, respective audio-visual settings of the video conferencing session applicable to the respective devices as a function of the capabilities of the respective devices; and
controlling, by the system, performance of the video conferencing session at the respective devices in accordance with the respective audio-visual settings.

17. The method of claim 16, wherein the respective audio-visual settings represent respective measures of audio and video quality and wherein the determining respective audio-visual settings comprises determining the respective audio-visual settings to balance the respective measures of audio and video quality at the respective devices.

18. The system of claim 16, further comprising:
monitoring, by the system, the respective measures of audio and video quality at the respective devices during the video conferencing session; and
adapting, by the system, the respective audio-visual settings based on changes to the respective measures of audio and video quality.

19. A non-transitory machine-readable medium, comprising executable instructions that, when executed by a processor, facilitate performance of operations, comprising:
determining capabilities of respective devices of participants of a video conferencing session provisioned via a communication network, the capabilities comprising audio-visual capabilities and connection capabilities of the respective devices related to communicating respective data streams of the video conferencing session via the communication network;
determining respective audio-visual parameters of the video conferencing session applicable to the respective devices as a function of the capabilities of the respective devices; and
controlling performance of the video conferencing session at the respective devices in accordance with the respective audio-visual parameters, wherein the respective audio-visual settings represent respective measures of audio and video quality and wherein the determining respective audio-visual settings comprises determining the respective audio-visual settings to balance the respective measures of audio and video quality at the respective devices.

20. The non-transitory machine readable-medium of claim 19, wherein the operations further comprise:
monitoring the respective measures of audio and video quality at the devices during the video conferencing session; and
adapting the respective audio-visual parameters based on changes to the respective measures of audio and video quality.
